(19) United States
(12) Patent Application Publication
(10) Pub. No.: US 2026/0343297 A1
(43) Pub. Date: Oct. 29, 2026

(54) METHODS AND APPARATUS FOR ENABLING WTRU COLLABORATION AND AGGREGATION OF PREPROCESSED MEASUREMENTS

(71) Applicant: InterDigital Patent Holdings, Inc., Wilmington, DE (US)

(72) Inventors: Virgile GARCIA, Antibes (FR); Pascal ADJAKPLE, Great Neck, NY (US); Ravikumar PRAGADA, Warrington, PA (US); Umer SALIM, Vallauris (FR); Guodong ZHANG, Woodbury, NY (US); Kyle Jung-Lin PAN, Saint James, NY (US); Yifan LI, Conshohocken, PA (US)

(73) Assignee: InterDigital Patent Holdings, Inc., Wilmington, DE (US)

(21) Appl. No.: 19/487,842

(22) PCT Filed: Jun. 3, 2024
(86) PCT No.: PCT/US2024/032236

§ 371 Date: Nov. 25, 2025

Related U.S. Application Data
(60) Provisional application No. 63/506,262, filed on Jun. 5, 2023.

(51) Int. Cl. H04W 24/10; H04B 17/318; H04W 84/04

(52) U.S. Cl. CPC H04W 24/10; H04B 17/328; H04W 84/042

(57) ABSTRACT

A first WTRU may receive, from a second WTRU, measurement configuration information and a request to report preprocessed measurement results. The first WTRU may determine, based on the measurement configuration information, one or more preprocessed measurement results. The preprocessed measurement results may include at least one of a Layer 1 filtered reference signal receive power (RSRP) or a Layer 1 filtered reference signal receive quality (RSRQ). The first WTRU may select at least one of the one or more preprocessed measurement results to send to the second WTRU. The first WTRU may receive, from the second WTRU, and in response to sending the preprocessed measurement results, an aggregated measurement result. The aggregated measurement results may be the result of applying a Layer 3 filter to at least the preprocessed measurement results determined by the first WTRU. The Layer 3 aggregated filter coefficients may be configured by RRC.

### CROSS-REFERENCE TO RELATED APPLICATIONS

This application claims the benefit of U.S. Provisional Application No. 63/506,262, filed Jun. 5, 2023, the contents of which are incorporated herein by reference.

### BACKGROUND

When a Wireless Transmit Receive Unit (WTRU) switches on, it may search for a Public Land Mobile Network (PLMN). The PLMN selection is performed at the Non Access Stratum (NAS) layer of the WTRU. Once a PLMN is selected, the WTRU may perform initial cell selection and search for a suitable cell in the selected PLMN. The cell selection is performed by the WTRU Access Stratum (AS) layer. When the WTRU AS layer selects a cell, the WTRU may camp on the selected cell. The WTRU may register its presence by means of a NAS registration procedure.

While in idle mode or inactive mode, the WTRU may perform received signal strength measurements on the selected cell and on neighbor cells. If the WTRU finds a more suitable cell, according to a cell reselection criteria, it may reselect into that cell and camp on it. The WTRU may also regularly search for higher priority PLMNs. If the WTRU NAS layer selects a new PLMN, the WTRU AS layer may search for a suitable cell in the newly selected PLMN and reselect into that cell and camp on it.

While camping on a cell, the WTRU may monitor the control channels of that cell to, e.g., acquire system information and receive paging messages. In order to be found by the network for paging purposes, the WTRU may notify its current location to the network. When reselecting into another cell, the WTRU may perform location update based upon changes on the tracking area or RAN notification area that the new cell belongs to.

### SUMMARY

WTRUs spend most of their time in RRC IDLE/INACTIVE mode states and, accordingly, power consumption associated with IDLE and INACTIVE mode operations may have a strong impact on the WTRU's battery life. Active sensing operations during IDLE and INACTIVE modes, such as scanning the radio channel for PLMN and cell selection and reselection, may be one of the key power drains in these modes of operation. Scanning all the capable frequencies and RATs is also time consuming, which may further impact WTRUs as it may cause delays in performing the PLMN and cell selection and reselection procedures.

Enabling a wide variety of devices and usages, some of the devices (for example, WTRUs and/or personal IoT network (PIN) elements) may be limited by the device's capabilities, power, energy, or connectivity to the network. Deploying a system where devices may collaborate and assist each other may improve the devices' performances. The devices may form groups of inter-connected WTRUs that may share their processing capabilities and communicate directly, typically using wireless communications such as NR sidelink. The devices may coordinate their procedures and communications to enhance each other's performance by aggregating their capabilities (e.g., processing, power, time, functionalities), and assist each other performing tasks and procedures.

One example use cases may include wearable connected objects, such as in the Extended Reality (XR) and/or Augmented Reality (AR)/Virtual Reality (VR) cases, where the devices may offload part of the processing (e.g., audio or video processing) to another more capable device. Another example use case may be when WTRUs may prefer to keep their main Uu radio off for certain periods of time to save power. In this example, if a relay device is present in the group, the WTRU may prefer to communicate to the network via the relay, while keeping their main Uu radio off.

Performing measurements, including collecting measurement samples and then processing the samples, may be a power consuming process. To save power, devices may leverage each other and perform aggregation of measurements. In one example, WTRUs may perform measurement aggregation for the purposes of cell selection, cell reselection, and/or PLMN selection. A first WTRU may be configured with parameters for measurement preprocessing and may obtain measurement results utilizing the preprocessing steps, according to the configuration. The first WTRU may share the preprocessed measurement results with a second WTRU. The second WTRU may aggregate the measurements, e.g., by adding signal strengths of the received measurements.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a diagram illustrating an example communications system in which one or more disclosed embodiments may be implemented;

FIG. 1B is a system diagram illustrating an example WTRU;

FIG. 1C is a system diagram illustrating the RAN and the CN according to an embodiment;

FIG. 1D is a system diagram illustrating the RAN and the CN according to an embodiment;

FIG. 2 illustrates an example of a measurement model;

FIG. 4 illustrates examples of direct communication between WTRUs;

FIG. 5 illustrates examples of roles in a group of WTRUs;

FIG. 6 illustrates an example of a control plane protocol stack with a collaboration layer;

FIG. 7 illustrates an example of control plane protocol stack for collaboration using PC5 interface;

FIG. 8 illustrates a diagram of an example of control plane protocol stack for inter-WTRU assistance where one WTRU may use two separate NAS entities for control;

FIG. 9 illustrates a diagram of an example of control plane protocol stack for inter-WTRU assistance where one NAS entity may control multiple WTRUs' AS entities;

FIG. 10 illustrates examples of the logical interfaces that may be used by the solutions;

FIG. 11 illustrates a call flow of an example of network-based WTRU coordinator selection;

FIG. 12 illustrates a call flow of an example of a WTRU-based coordinator selection;

FIG. 13 illustrates a call flow of an example of network-based aggregated WTRU selection;

FIG. 14 illustrates a call flow of an example of autonomous aggregated WTRU selection;

FIG. 15 illustrates a call flow of an example of a procedure for multi-WTRU aggregated measurement;

FIG. 16 illustrates a call flow of an example of lower-layer aggregation for cell (re)selection performed by an anchor WTRU;

FIG. 17 illustrates a call flow of an example of lower-layer aggregation for cell (re)selection performed by an aggregated WTRU;

FIG. 18 illustrates a call flow of an example of lower-layer aggregation for PLMN selection performed by an aggregated WTRU;

FIG. 19 illustrates a flow diagram of an example of cell/PLMN (re)selection procedure with estimated aggregation measurements;

FIG. 20 illustrates a flow diagram of an example of a method for low-layer PHY aggregation measurements for an anchor WTRU;

FIG. 21 illustrates a flow diagram of an example of a method for low-layer PHY aggregation measurements for an aggregated WTRU;

FIG. 22 illustrates a flow diagram of an example of a method for cell selection for an anchor WTRU with low-layer PHY measurement aggregation estimation; and

FIG. 23 illustrates a flow chart of an example of a measurement aggregation procedure.

### DETAILED DESCRIPTION

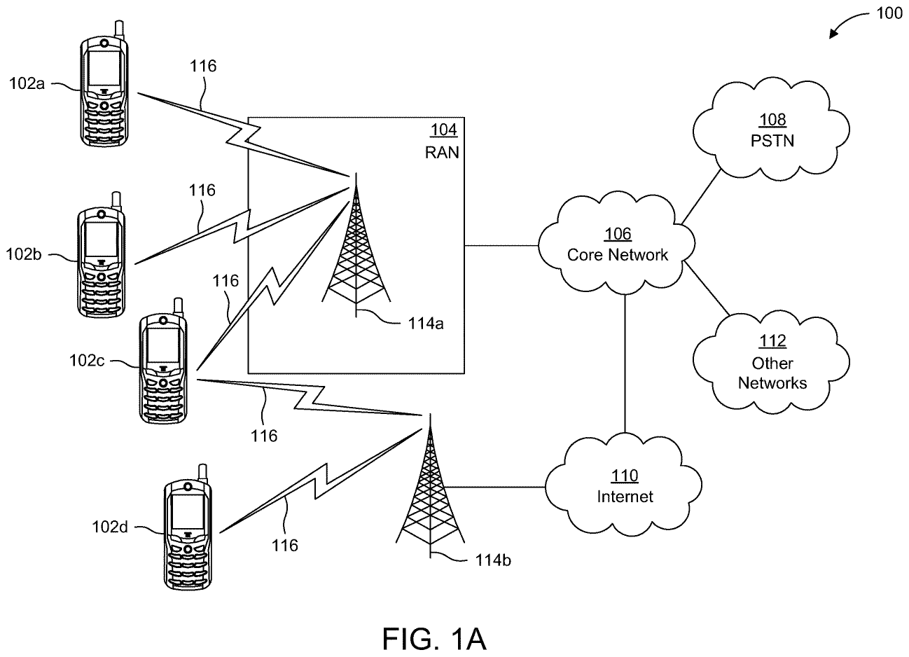

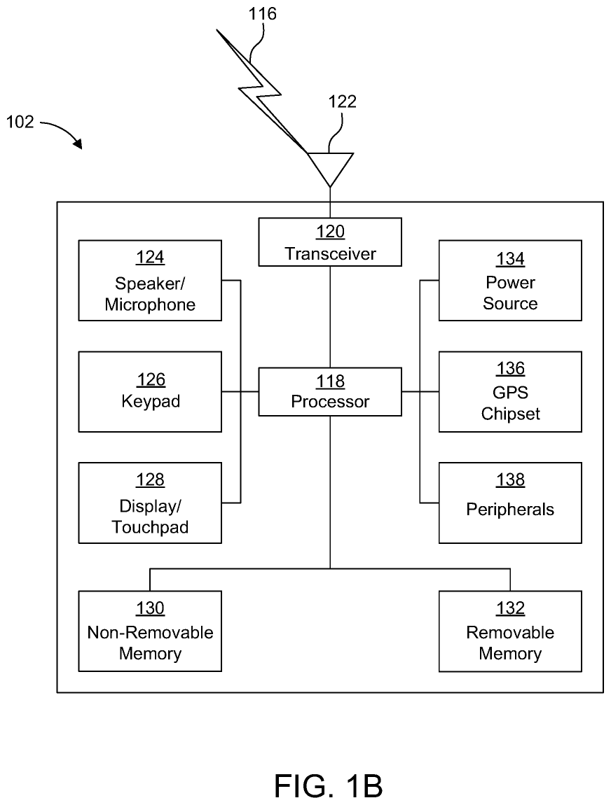

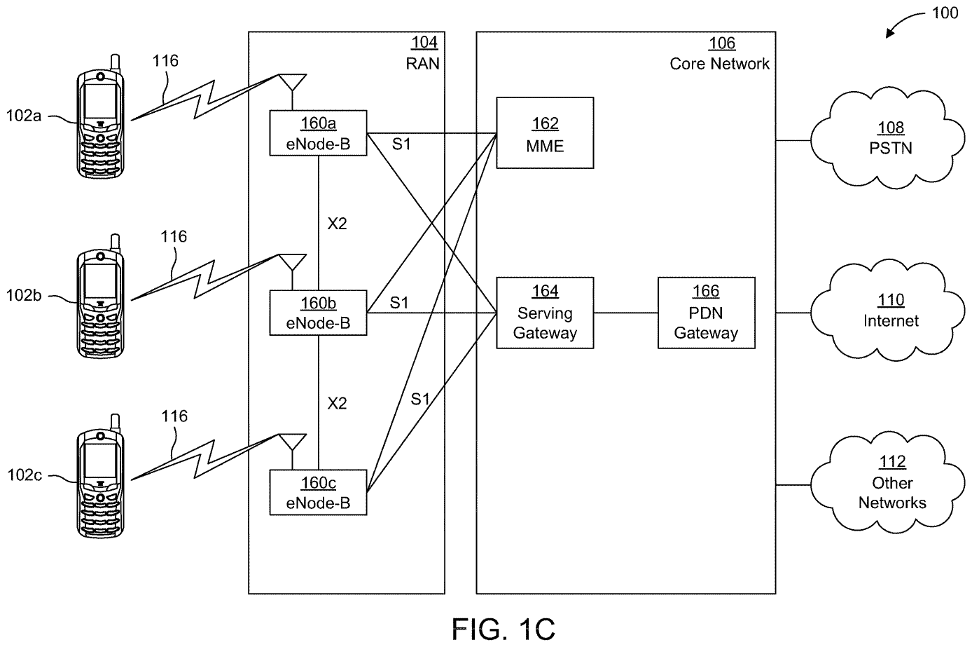

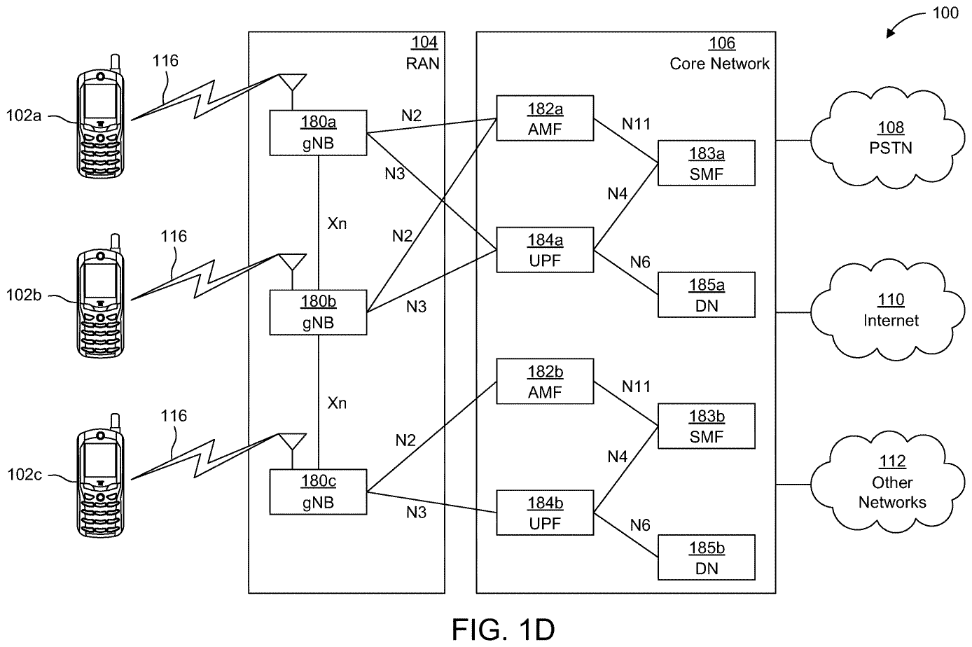

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) PacketAccess (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

WTRUs implementing 3GPP wireless radio access technologies (RAT), including o 2G, 3G, 4G and/or 5G RATs may perform PLMN selection, cell selection/reselection, and location registration including tracking-area update procedures while in RRC_IDLE mode, or RRC_INACTIVE mode. 5G devices may also support RAN Notification Area (RNA) updates and operation in an RRC_INACTIVE state.

When a WTRU is switched on, a PLMN is selected by the WTRU. For the selected PLMN, associated RAT(s) may be set. With cell selection, the WTRU may search for a suitable cell of the selected PLMN, choose the cell to provide available services, and monitor its control channel. The WTRU may register its presence by means of a NAS registration procedure in the tracking area of the chosen cell.

While in RRC_IDLE, a WTRU can perform received-signal-strength measurements on serving and/or neighbor cells. The WTRU may find a more suitable cell according to the cell reselection criteria, it may reselect onto that cell and camp on it. If this new cell does not belong to at least one tracking area to which the WTRU is registered, then the WTRU may initiate a location registration procedure. The WTRU may search for higher-priority PLMNs at regular time intervals. If a different PLMN is selected by the WTRU's NAS layer, the WTRU may search for a suitable cell in the new PLMN.

If a WTRU loses coverage of the registered PLMN, a new PLMN may be selected automatically by the WTRU. Optionally, an indication of available PLMNs may be given to the user via the WTRU so that the user can perform a manual selection. Various means of control exist for the network to prioritize cell selection onto certain RATs, to control the rate at which low-, medium- or high-mobility WTRUs perform cell reselection and to bar selected tracking areas from reselection by WTRUs.

When the WTRU camps on a cell in RRC_IDLE state or in RRC_INACTIVE state, it may receive system information from the PLMN, it may establish an RRC connection or resume a suspended RRC connection, and it may receive Earthquake and Tsunami Warning System (ETWS) or Commercial Mobile Alert System (CMAS) notifications. Moreover, if the network needs to send a control message or deliver data to a registered WTRU, the network “knows,” in most cases, the set of tracking areas where the WTRU is camped. A paging message may be sent for the WTRU on the control channels of all the cells in the corresponding set of tracking areas. The WTRU may receive the paging message and respond.

The WTRU may scan all RF channels in the NR bands according to the WTRU's capabilities to find available PLMNs and available CAGs. On each carrier, the WTRU typically searches for the strongest cell and reads the cell's system information, to find out which PLMN(s) the cell belongs to and any associated Cell Access Groups (CAGs). For operation with shared spectrum channel access, the WTRU may also read the system information of multiple strongest cell(s). If the WTRU can read one or several PLMN identities in the strongest cell, or in multiple strongest cell(s) in case of operation with shared spectrum channel access, each found PLMN may be reported to the NAS as a high quality PLMN (but without the RSRP value) and any associated CAG-ID, provided that the following high-quality criteria is fulfilled: For an NR cell, the measured Reference Signal Receive Power (RSRP) value is greater than or equal to −110 dBm.

Found PLMNs that do not satisfy the high-quality criteria, but for which the WTRU was able to read the PLMN identities, are reported to the NAS together with their corresponding RSRP values and any associated CAG-ID. The quality measure reported by the WTRU to the NAS shall be the same for each PLMN found in one cell.

The search for PLMNs may be stopped on request from the NAS. The WTRU may improve, or even optimize, PLMN search by using stored information, e.g., frequencies and optionally also information on cell parameters from previously received measurement control information elements.

After the WTRU has selected a PLMN, the cell-selection procedure may be performed to select a suitable cell of that PLMN for the WTRU to camp on.

Home PLMN: This is a PLMN where the MCC and MNC of the PLMN identity match the MCC and MNC of the IMSI according to known matching criteria.

EHPLMN: Any of the PLMN entries contained in the Equivalent HPLMN list.

Equivalent HPLMN list: To allow provision for multiple HPLMN codes, PLMN codes that are present within this list replace the HPLMN code derived from the IMSI for PLMN selection purposes. This list is stored on the USIM and is known as the EHPLMN list. The EHPLMN list may also contain the HPLMN code derived from the IMSI. If the HPLMN code derived from the IMSI is not present in the EHPLMN list then it is treated as a Visited PLMN for PLMN selection purposes.

Visited PLMN: This is a PLMN different from the HPLMN (if the EHPLMN list is not present or is empty) or different from an EHPLMN (if the EHPLMN list is present).

The WTRU normally operates on its home PLMN (HPLMN) or equivalent home PLMN (EHPLMN).

However, a visited PLMN (VPLMN) may be selected, e.g., if the WTRU loses coverage. There are two modes for PLMN selection: In the automatic mode, The WTRU may utilize a list of PLMN/access technology combinations in priority order. The highest priority PLMN/access technology combination which is available and allowable is selected. In the manual mode, the WTRU may indicate to the user which PLMNs are available. Only when the user makes a manual selection does the WTRU try to obtain normal service on the VPLMN.

Cell selection may be initial cell selection (e.g., no prior knowledge of which RF channels are NR frequencies) or cell selection leveraging existing information.

In initial cell selection, the WTRU may scan all RF channels in the NR bands according to the WTRU's capabilities to find a suitable cell. On each frequency, the WTRU may search for the strongest cell (except for operation with shared spectrum channel access where the WTRU may search for the next strongest cell(s)). Once the WTRU finds a suitable cell, this cell may be selected.

In cell selection by leveraging stored information, the WTRU uses stored information on frequencies and, optionally, information on cell parameters from previously received measurement control information elements or from previously detected cells. Once the WTRU finds a suitable cell, the cell may be selected. If no suitable cell is found, the initial cell selection procedure may be started.

The NAS may control the RAT(s) in which the cell selection should be performed, for instance by indicating RAT(s) associated with the selected PLMN, and by maintaining alist of forbidden registration area(s) and a list of equivalent PLMNs.

The WTRU may perform measurements for cell selection and reselection purposes. The WTRU may select a suitable cell based on RRC_IDLE or RRC_INACTIVE state measurements and cell (re)selection criteria.

For cell reselection, to limit the number of measurements the WTRU is required to make, the WTRU first verifies if certain conditions are met. If conditions are met, then the WTRU may start performing measurements in neighbour cells.

When evaluating Srxlev and Squal of non-serving cells for reselection evaluation purposes, the WTRU may use parameters provided by the serving cell. For the final check on cell reselection criteria, the WTRU may use parameters provided by the target cell.

When camped on a cell, the WTRU may regularly search for a better cell according to the cell reselection criteria. If a better cell is found, the WTRU may reselect to that cell. The change of cell may imply a change of RAT.

As an example, the cell selection criterion S may be fulfilled when:

Srxlev>0 and Squal>0, where:
where:
Srxlev is the cell selection RX level value (in dB) and is determined as:

Srxlev=Qrxlevmeas−(Qrxlevmin+Qrxlevminoffset)−Pcompensation−Qoffsettemp; where:

Qrxlevmeas: Cell RX level value (Reference Signal Receive Power, RSRP). Measured by the WTRU.

Qrxlevmin: Minimum required RX level in the cell (dBm). Configured by RRC.

Qrxlevminoffset: Offset used while camped in a VPLMN and searching for a higher priority PLMN. Configured by RRC.

Pcompensation: For FR1: dependent on the WTRU power class, configured by RRC. For FR2=0.

Qoffsettemp: Offset temporarily applied to a cell. Configured by RRC.

Qrxlevminoffset: Offset used while camped in a VPLMN and searching for a higher priority PLMN. Configured by RRC.

Qrxlevminoffsetcell: Cell specific offset, added to the corresponding Qrxlevmin to achieve the required minimum RX level in the concerned cell. Configured by RRC.

Squal is the cell selection quality value (in dB) and is determined as:

Squal=Qqualmeas−(Qqualmin+Qqualminoffset)−Qoffsettemp

Qqualmeas: Cell quality value (Reference Signal Receive Quality, RSRQ). Measured by the WTRU.

Qqualmin: Minimum required quality level in the cell (dB). Configured by RRC.

Qqualminoffset: Offset used while camped in a VPLMN and searching for a for higher priority PLMN. Configured by RRC.

Qoffsettemp: Offset temporarily applied to a cell. Configured by RRC.

Absolute priorities of different NR frequencies or inter-RAT frequencies may be provided to the WTRU in the system information, in the RRC Release message, or by inheriting from another RAT at inter-RAT cell (re)selection. In the case of system information, an NR frequency or inter-RAT frequency may be listed without providing a priority (i.e., the field cellReselectionPriority is absent for that frequency).

Different rules may apply to different priorities. In one example, if the serving cell does not fulfil Srxlev>SlntraSearchP and Squal>SlntraSearchQ, the WTRU may perform intra-frequency measurements. In another example, for a NR inter-frequency or inter-RAT frequency with a reselection priority higher than the reselection priority of the current NR frequency, the WTRU may perform measurements of higher-priority NR inter-frequency or inter-RAT frequencies. In another example, for a NR inter-frequency with an equal or lower reselection priority than the reselection priority of the current NR frequency and for inter-RAT frequency with lower reselection priority than the reselection priority of the current NR frequency, in the case where the serving cell does not fulfil Srxlev>SnonlntraSearchP and Squal>SnonlntraSearchQ, the WTRU may perform measurements of NR inter-frequency cells of equal or lower priority, or inter-RAT frequency cells of lower priority.

If threshServingLowQ is broadcast in system information and more than 1 second has elapsed since the WTRU camped on the current serving cell, cell reselection to a cell on a higher-priority NR frequency or inter-RAT frequency than the serving frequency is performed if a cell of a higher priority NR or EUTRAN RAT/frequency fulfils Squal>Thresh_(X, HighQ) during a time interval TreselectionRAT. Otherwise, cell reselection to a cell on a higher priority NR frequency or inter-RAT frequency than the serving frequency is performed if a cell of a higher priority RAT/frequency fulfils Srxlev>Thresh_(X, HighP) during a time interval TreselectionRAT and more than 1 second has elapsed since the WTRU camped on the current serving cell.

Cell reselection to a cell on an equal priority NR frequency is based on ranking for intra-frequency cell reselection.

If threshServingLowQ is broadcast in system information and more than 1 second has elapsed since the WTRU camped on the current serving cell, cell reselection to a cell on a lower-priority NR frequency or inter-RAT frequency than the serving frequency may be performed if the serving cell fulfils Squal<Thresh_(Serving, LowQ) and a cell X of a lower-priority NR or E-UTRAN RAT/frequency fulfils Squal>Thresh_(X, LowQ) during a time interval TreselectionRAT. Otherwise, cell reselection to a cell on a lower-priority NR frequency or inter-RAT frequency than the serving frequency is performed if the serving cell fulfils Srxlev<Thresh_(Serving, LowP) and a cell X of a lower priority RAT/frequency fulfils Srxlev>Thresh_(X, LowP) during a time interval TreselectionRAT; and more than 1 second has elapsed since the WTRU camped on the current serving cell.

Regarding measurements for RRC_IDLE and INACTIVE modes, the WTRU may performs measurement for cell selection and reselection purposes.

When evaluating Srxlev and Squal of non-serving cells for reselection evaluation purposes, the WTRU uses parameters provided by the serving cell. For the final check on cell selection criteria, the WTRU may use parameters provided by the target cell for cell reselection.

The devices, e.g., WTRUs, may measure the Reference Signal Receive Power (RSRP) and Reference Signal Receive Quality (RSRQ) of cells based on the Cell Defining (CD) SSB, i.e., the SS-RSRP and SS-RSRQ.

Synchronization signal (SS) reference signal received power (SS-RSRP) is defined as the linear average over the power contributions (in [W]) of the resource elements that carry secondary synchronization signals.

SS-RSRP may be measured only among the reference signals corresponding to SS/PBCH blocks with the same SS/PBCH block index and the same physical-layer cell identity. If SS-RSRP is not used for L1-RSRP and higher-layers indicate certain SS/PBCH blocks for performing SS-RSRP measurements, then SS-RSRP is measured only from the indicated set of SS/PBCH block(s).

In multi-beam operations, the cell quality may be derived amongst the beams corresponding to the same cell.

Secondary synchronization signal reference signal received quality (SS-RSRQ) is defined as the ratio of NxSS-RSRP/NR carrier Received Signal Strength Indicator (RSSI), where N is the number of resource blocks in the NR carrier RSSI measurement bandwidth. The measurements in the numerator and denominator shall be made over the same set of resource blocks.

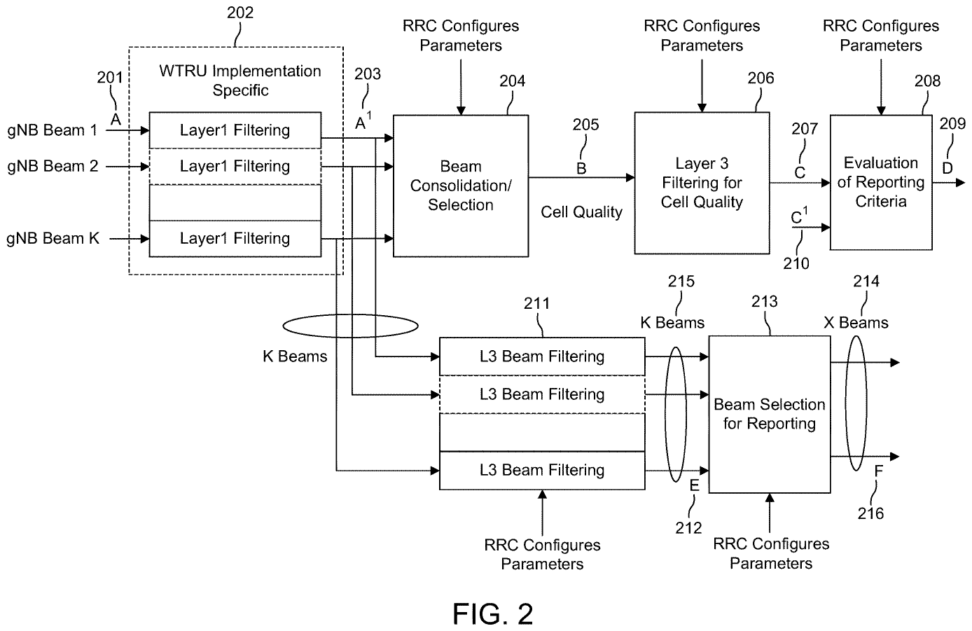

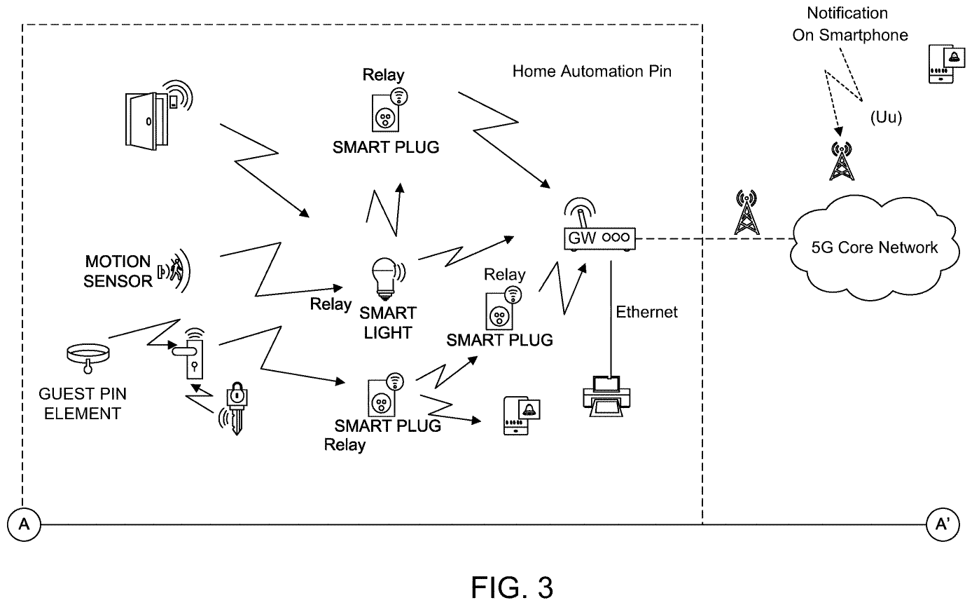

FIG. 2 illustrates an example of a measurement model.

For measurement processing, two types of filters may be involved: Layer 1 filter and Layer 3 filter. They are applied in sequence, as described herein and illustrated in FIG. 2.

Layer 1 (L1) filtering involves processing raw measurements samples. The type of processing may vary between devices (i.e., it is not standardized). It may involve averaging samples taken during a period of time, or averaging a given number of samples, or performing a moving average, etc. This filtering is performed directly in measurement samples collected by the physical layer (i.e., Layer 1) in the device. The result is referred to as Layer 1 filtered measurement results.

Layer 3 (L3) filtering involves processing the Layer 1 filtered measurement results. The device may apply Layer 3 filtering using Layer 3 filter coefficients provided by the network, via RRC signalling. The Layer 3 filter coefficients may be coefficients that are used in an equation/function which is applied to the Layer 1 filtered measurement results. The result is referred to as Layer 3 filtered measurement results. The device may report the Layer 3 filtered measurement results to the network.

Layer 3 filter may also be referred to as RRC configured filter.

As shown in FIG. 2, the beam specific samples (A) may represent the measurements internal to the physical layer 201. The beam specific samples (A) may be the input to a Layer 1 filtering 202. Exact filtering may vary depending on implementation choice. The process utilized to perform measurements in the physical may vary (e.g., inputs A and Layer 1 filtering may be implementation specific).

The output of Layer 1 filtering, A1 203, may be reported by Layer 1 to Layer 3 211.

Beam consolidation/selection 204 may be used to consolidate beam specific measurements to derive cell quality 205. The behavior of the beam consolidation/selection 204 may be standardized, and the configuration of this module may be provided by RRC signaling. The cell quality, B 205, may be derived from beam-specific measurements reported to Layer 3 after the beam consolidation/selection 205. The reporting period at B 205 may equal one measurement period at A1 203.

Further Layer 3 filtering 206 for cell quality 205 may be performed on the measurements provided at point B 205. The behavior of the Layer 3 filters may be standardized and the configuration of the Layer 3 filters may be provided by RRC signaling. The filtering reporting period at C 207 may equal one measurement period at B 205.

The result after a measurement is processed by the Layer 3 filter is represented by C in FIG. 2 207. The reporting rate may be identical to the reporting rate at point B 205. This measurement may be used as input for one or more evaluation of reporting criteria 208.

Evaluation of reporting criteria 208 may be the process of verifying whether measurement reporting is necessary at point D 209. The evaluation may be based on more than one flow of measurements at reference point C 207, for example to compare between different measurements. This is illustrated by input C 207 and C1 210. The WTRU may evaluate the reporting criteria at least every time a new measurement result is reported at point C 207, or C1 210. The reporting criteria may be standardized and the configuration may be provided by RRC signaling (e.g., WTRU measurement report configuration).

D 209, as shown in FIG. 2, represents the measurement report information sent on the radio interface (e.g., on a message).

L3 beam filtering 211 may be performed on the measurements provided at point A1 203 (e.g., on the beam specific measurements). The behavior of the beam filters may be standardized and the configuration of the beam filters may be provided by RRC signaling. Filtering reporting period at E may equal one measurement period at A1.

E 212 represents measurements (e.g., beam-specific measurement) after processing in the L3 beam filter 211. Those measurements are associated with K beams 215. The reporting rate may be identical to the reporting rate at point A1 203.

The beam selection process 213 may result in the selection of X beams 214 out of the K beams 215 measurements provided at point E 212, resulting in the measurement in point F 216. The behavior of the beam selection may be standardized and the configuration of this module may be provided by RRC signaling.

F 216 represents beam measurement information included in a measurement report (e.g., sent) on the radio interface.

Layer 1 filtering may employ a certain level of measurement averaging. How and when the WTRU exactly performs the required measurements may be implementation specific and may be based on some predetermined performance requirements of the output at B 205. Layer 3 filtering for cell quality 206, and associated parameters, may not introduce any delay in the sample availability between B 205 and C 207, ideally. C1 210 is the input used in the event evaluation for reporting criteria 208. L3 beam filtering 211 and associated parameters may not introduce any delay in the sample availability between E 212 and F 216, ideally.

Measurements are subject to accuracy considerations as is known, where the accuracy requirements are defined for the absolute and relative measurements of RSRP and RSRQ, for different scenarios, such as depending on the frequency range, the mode of operation, and/or the temperature.

The use cases described may use various connectivity between the WTRUs, including NR sidelink over licensed bands or unlicensed bands, and WTRUs connecting through the network, including NR Uu. Furthermore, devices such as WTRUs may have multiple radios, where one is dedicated to direct inter-WTRU (e.g., sidelink) and one to the network (Uu). Groups of WTRUs may be formed using sidelink connections between the users while only part of the users of the group may have activate Uu radios.

Personal IoT Networks (PINs) and Customer Premises Networks (CPNs) provide local connectivity between WTRUs and/or non-3GPP devices. The CPN via an eRG, or PIN Elements via a PIN Element with Gateway Capability can provide access to 5G network services for the WTRUs and/or non-3GPP devices on the CPN or PIN. CPNs and PINs have in common that in general they are owned, installed, and/or (at least partially) configured by a customer of a public-network operator.

A Customer Premises Network (CPN) is a network located within a premises (e.g., a residence, office, and/or shop). The CPN may provide connectivity to the 5G network via an evolved Residential Gateway (eRG). The eRG may be connected to the 5G core network via wireline, wireless, or hybrid access. A Premises Radio Access Station (PRAS) is a base station installed in a CPN. Through the PRAS, WTRUs can get access to the CPN and/or 5G network services. The PRAS may be configured to use licensed, unlicensed, or both frequency bands. Connectivity between the eRG and the WTRU, non-3GPP Device, or PRAS may use any suitable 3GPP or non-3GPP technology (e.g., Ethernet, optical, WLAN).

A Personal IoT Network (PIN) includes PIN Elements that communicate using PIN Direct Connection or direct network connection and is managed locally (using a PIN Element with Management Capability). A PIN includes at least one PIN Element with gateway capability and at least one PIN Element with management capability. Examples of PINs include networks of wearables and smart-home/smart-office equipment.

PIN Elements may have access to 5G network services via a PIN Element with gateway capability. Using the PIN Element with gateway capability, PIN Elements may be able to communicate with other PIN Elements that may not be within range to use a PIN Direct Connection.

A PIN Element with management capability is a PIN Element that provides a means for an authorized administrator to configure and to manage a PIN.

FIG. 3 illustrates an example of a network comprising a plurality of personal IoT networks (PINs) and PIN elements;

Use cases may include wearable connected objects, such as in the Extended Reality (XR) and/or Augmented Reality (AR)/Virtual Reality (VR) cases, where the devices may be offloading part of the processing (e.g., audio, video) to a more capable device. The devices may form groups of inter-connected WTRUs that may share their processing capabilities and require communications, typically as wireless communication such as NR sidelink. Industrial network and Industrial IoT (IIoT) use cases may leverage the WTRU collaboration/aggregation framework, where devices such as sensors may be inter-connected, e.g., for redundancy or reliability.

WTRUs may be grouped to assist each other and improve the performance of the devices. Typically, a higher-capable device may assist a lower-capable device to perform some procedures or relay the higher-capable device's signal. Motivations can range from device hardware (small form factor, low-cost device, limited hardware) to energy considerations (low power or low-battery device may reduce its capabilities to save power) or even assistance for coverage and reliability improvements.

WTRU aggregation may refer to an relay solution with specific multi-path properties. This multi-path relay solution may be utilized for WTRU aggregation, where a WTRU is connected to the network via two links: via a direct path and via another WTRU using a proprietary (non-standardized) WTRU-WTRU interconnection. WTRU aggregation aims to provide applications requiring high UL bitrates on 5G terminals, in cases when normal WTRUs are too limited by UL WTRU transmission power to achieve required bitrate, especially at the edge of a cell. Additionally, WTRU aggregation may improve the reliability and stability, and reduce delay of services If the channel conditions of a terminal is deteriorating, another terminal be used to make up for the traffic performance unsteadiness caused by channel-condition variation.

In an aggregation context, an anchor WTRU is a WTRU that is the source or destination of the traffic and payload data, that may use an aggregated WTRU as a relay. An anchor WTRU may or may not have a direct connection to the network. An aggregated WTRU is a WTRU that assists/helps an anchor WTRU to access the network. In the context of NR sidelink (SL) relay, the anchor WTRU may correspond to a remote WTRU and the aggregated WTRU may correspond to a relay WTRU. To assist the anchor WTRU, the aggregated WTRU may need to camp/connect to the serving cell of the anchor WTRU, which may not be the same as its own serving cell.

A remote WTRU may be out of network coverage. A relay WTRU may be in network coverage and may be able to relay traffic to/from a remote WTRU from/to the network.

WTRU aggregation may involve a scenario where the WTRU collaboration is expected to enable functionality beyond relaying. WTRUs may aggregate their capabilities (processing, power, time, functionalities) and assist each other performing tasks and procedures.

In the description that follows, the terms “aggregated WTRU” and “assisting WTRU” may be used interchangeably; the terms “anchor WTRU” and “assisted WTRU” may be used interchangeably.

Embodiments including procedures, signaling, and configuration for collaboration and aggregation of measurements between WTRUs in RRC IDLE or INACTIVE modes are described, including: enablement of low-layer aggregation of measurements for joint signal processing between aggregated WTRUs, and how to process and evaluate the received measurements for cell and PLMN (re)selection; and enablement of low-layer aggregation-based cell and PLMN selection without measurement feedback, by estimating the aggregation gain on the measurement.

WTRUs may be configured to assist each other to perform measurements for PLMN selection, cell selection and cell reselection. The measurements from the WTRU and its assisting/aggregated WTRUs may then be used for the evaluation and selection procedures, with specific bias to consider the fact that some measurements are not locally performed.

One example of application of the solutions described is when WTRUs are equipped with multiple radios, e.g., NR SL+NR Uu, and the sidelink is already used for aggregation/grouping purposes (e.g., application/user needs), and the collaboration may be used to avoid turning on the main Uu radio as much as possible to save WTRU energy.

As described, the assisting WTRU and assisted WTRU both perform the measurements, and the measurements may be combined/aggregated (e.g., using joint signal processing) to obtain improved signal strength and leverage the assisting WTRU capabilities. In a typical case, the anchor/assisted WTRU may request the aggregated WTRU to perform measurements. The aggregated WTRU may measure and forward the measurements to the anchor WTRU. The anchor WTRU may aggregate the measurements, possibly with dedicated processing steps, and use that aggregated measurement to perform the requested procedure, e.g., PLMN or cell (re)selection. The aggregation of signals may improve the signal quality, enable the anchor WTRU to increase its coverage, and reduce the time needed to find a suitable cell.

Measurement aggregation: The aggregation of measurements may be performed in different ways, for instance: raw measurement samples may be added, absolute power value of the raw measurement samples may be added, filtered measurement results may be added, or absolute power value of the filtered measurement samples may be added. As an example, the RSRP values, in the linear domain, may be added. In another example, the RSRP and RSSI values may be first combined/added and then the RSRQ value may be determined based on the combined RSRP and RSSI.

The WTRU may aggregate measurement results received from different WTRUs.

The WTRU may include its own measurement results in the aggregation.

Aggregating measurements may allow for diversity gain. For example, an assisted WTRU may aggregate its own measurements with measurements received from an assisting WTRU. Assuming similar channel conditions for both WTRUs, roughly a 3 dB gain may be observed in this case. If the assisted WTRU aggregates with more assisting WTRU's measurements, the gains may be higher: for similar channel conditions, with 4 WTRUs, a 6 dB gain may be observed, roughly. These are only theoretical examples to explain the concept; as channel conditions are unlikely to be the same.

The solutions described may be applied either over licensed or unlicensed spectrum, depending on the procedure. The cell and PLMN selection procedures may be performed when the WTRU is not yet camping or attached to a cell, hence it may not have the network configuration. One example is the case of NR sidelink in unlicensed bands, where the WTRUs may perform communications without network configuration or coverage (e.g., using autonomous resource allocation, e.g., mode 2). For NR sidelink using licensed spectrum, the network may configure when the measurements may performed for the cell reselection case, or when the collaboration may be used for PLMN when searching for a higher-priority PLMN after one is already selected. Cell selection may also be triggered by state transition, e.g., the reception of RRC release message, that may contain network information.

Examples are provided using 3GPP technologies, e.g., 5G NR. In a variation of the solutions, the inter-WTRU communication may be performed using non-3GPP communications such as Wi-Fi or Bluetooth.

Examples are provided for the aggregation between two WTRUs. Similar aggregation with more WTRUs is also envisioned using the same methods and procedures described.

The WTRU aggregation may be performed using inter-WTRU connection, such as PC5 (sidelink) or any other communication system, such as Wi-Fi, Bluetooth, wired connection. NR sidelink is used to help exampling the concepts, but any other inter-WTRU interface may be used.

The WTRUs may or may not be under the coverage of the network, the connection to the network may not be necessary to perform direct inter-WTRU aggregation.

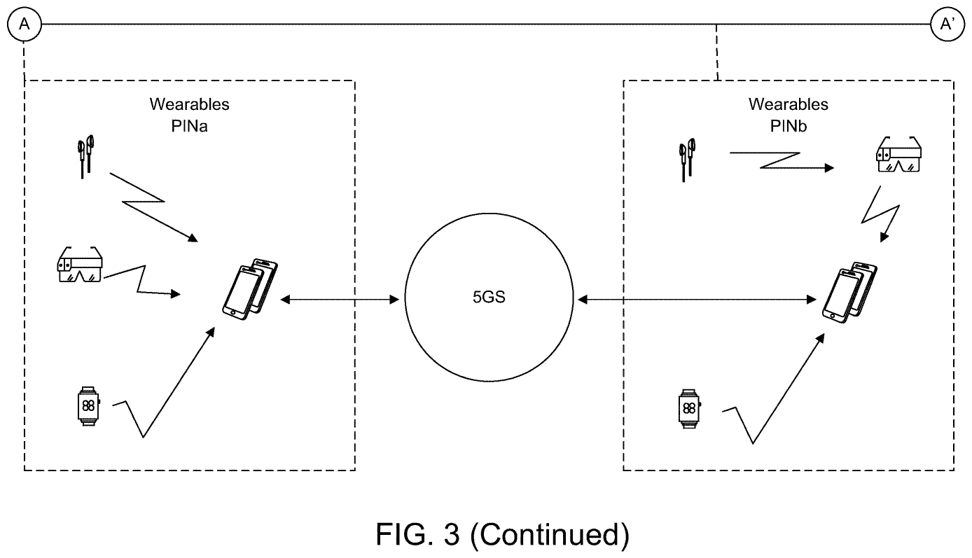

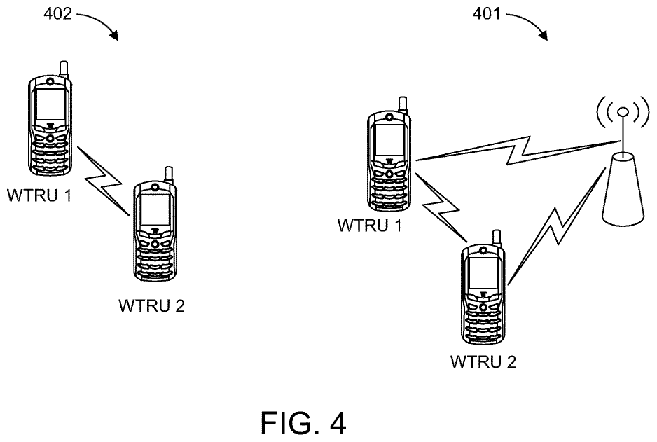

FIG. 4 illustrates examples of direct communication between WTRUs. As shown, the WTRUs may be within network coverage 401 or outside network coverage 402.

In some cases, such as in Personal IoT Networks (PINs), tethered devices (e.g., XR, wearables), Industrial IoT devices, or interactive services, the devices may need to communicate with each other for the service or application they are interested in. Group of devices may be formed based on the service or application, where the devices may communicate with each other and, in addition, may have a network connection. In the application or service-oriented groups, the WTRUs in the group may be selected and managed by the service/application in a higher layer. The group formation communication exchanges may be configured during the PC5 connection establishment phase, or after the connection is established using PC5-RRC or PC5-Signaling (PC5-S) types of signaling.

The groups of WTRUs may either be static (e.g., fixed size and devices in the group) or dynamic, where WTRUs may be added and removed, depending on, for example, the deployment, devices and services.

Depending on the purpose of the group, certain requirements, such as performance requirements, and connectivity between WTRUs in a group may be configured.

For example, one connectivity aspect that may be required is that a group (or a part of a group) be served by the same cell, same gNB, or same PLMN. This requirement may be useful for devices that support multi-path (Uu and SL) but do not support being relayed by a WTRU that is not served by the same cell. This may also be a requirement of the network to facilitate the management and communication with the WTRUs without inter-gNB or roaming exchanges.

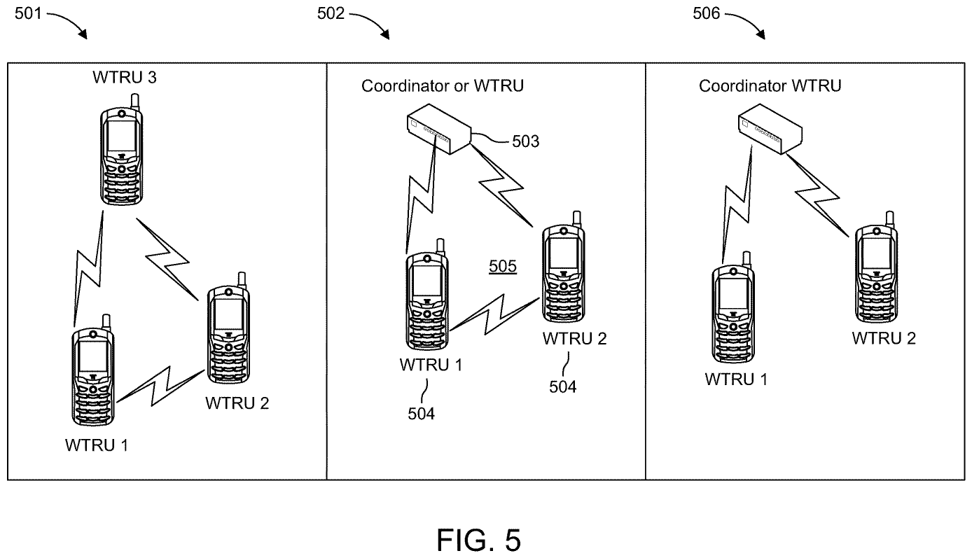

FIG. 5 illustrates examples of roles in a group of WTRUs. In a group, the WTRUs may have different roles depending on the hierarchy between them In one example, the WTRUs may be viewed as peers in a group 501. In this case, there may be no user managing the others. Collaboration within the group involves sharing information, requesting assistance, or forwarding data or control information to each other.

In another example 502, a WTRU coordinator 503 is connected to other WTRUs 504. The coordinator 503 device may take the role of a manager, coordinator, or controller for other devices 504. A coordinator WTRU may be connected to the other devices and may centralize the information distribution among the WTRUs. A WTRU coordinator may centralize the decisions and information in the group and be used to offload tasks or procedures. A WTRU coordinator may facilitate the collaboration among the other WTRUs or of themselves with the other WTRUs. When a coordinator WTRU is present, the direct inter-WTRU collaboration link 505 between two WTRUs performing the collaboration may not be necessary 506.

In a group of WTRUs, one WTRU may take the role of coordinator WTRU. This device takes the responsibility to coordinate the WTRUs of the group to perform tasks jointly or to perform tasks on behalf of the other WTRUs in the group. The coordinator WTRU may also provide the WTRUs of the group with connectivity to the network (e.g., as a relay or gateway). The coordinator WTRU may need to have capabilities to perform the collaboration, including a strong connectivity with the other WTRUs in the group.

The WTRU information shared between WTRUs of a group may be transmitted through the coordinator WTRU, especially when there is no direct connection between the WTRUs performing the collaboration. The information may also be shared via the network (e.g., through Uu interface, e.g., via RRC or higher layer signaling).

The coordinator WTRU may receive the collaboration information from WTRUs and transmit it to the corresponding destinations. The coordinator WTRU may also store the collaboration information to share it with users later, upon request. A WTRUs may request the coordinator WTRU for information that corresponds to a specific WTRU or information associated with the group.

The collaboration between WTRUs requires specific procedures and implementation capabilities. Some devices may implement the necessary features to be a group coordinator, and these features may be represented by a specific WTRU category or WTRU class.

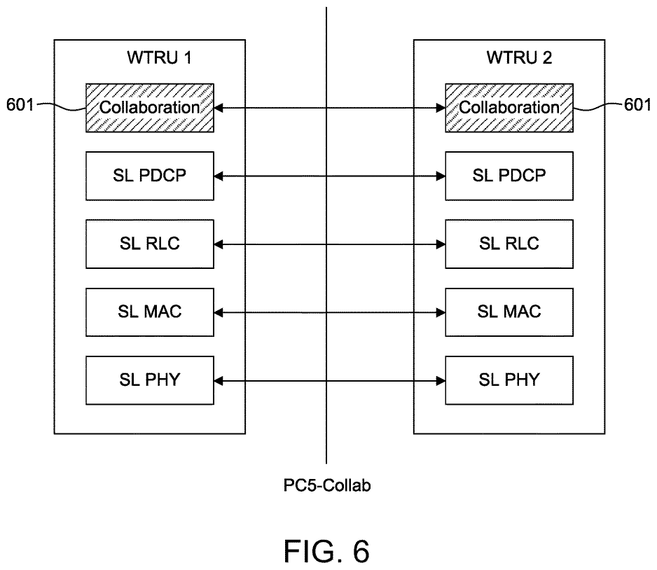

FIG. 6 illustrates an example of a control plane protocol stack with a collaboration layer. In this example, the collaboration layer 601 of the WTRUs communicate via direct PC5 communication.

The PC5 collaboration (PC5-Collab) interface may be a dedicated interface, possibly with a dedicated SRB to exchange collaboration information. Alternatively, and interchangeably, the PC5 collaboration may use PC5 Signaling (PC5-S) or SL RRC messages (PC5-RRC).

One of the purposes of the collaboration layer is to enable collaboration and communication between layers of protocol stacks, both for Non-Access Stratum (NAS) and Access Stratum (AS) control planes of different WTRUs. Each of the layers perform their own tasks for the connectivity, data transmission and data reception. The collaboration functionality added to the WTRU may serve as an input to be used in the tasks, procedures and decisions made in each of the WTRU's layers.

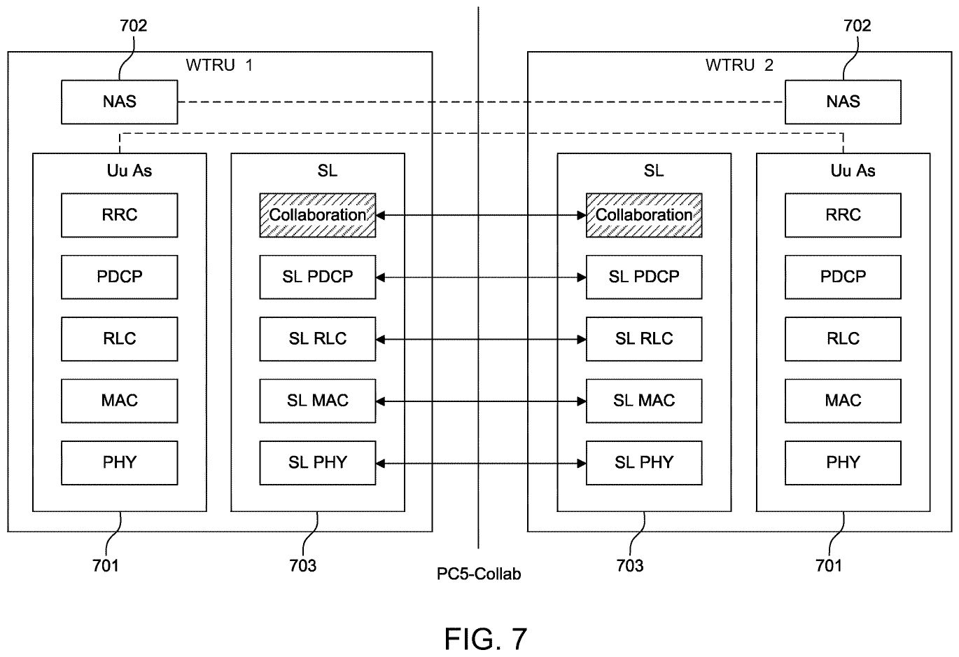

FIG. 7 illustrates an example of control plane protocol stack for collaboration using PC5 interface. In this example, using 3GPP architecture and a sidelink for inter-WTRU communication, both the Uu AS 701 and the NAS 702 of WTRUs may be communicating and exchanging messages with each other, via the PC5-Collab/sidelink 703. At the Uu AS level, the inter-WTRU communication may be performed between any Uu layer, such as PHY, MAC, RLC, PDCP or RRC, through the collaboration layer 703. The collaboration layer may communicate internally, in a given WTRU, with all Uu AS layers, either directly or indirectly (e.g., via NAS layer). Optionally, as discussed before, a more distributed approach may be used.

In one example, WTRU1 may offload one or more tasks to WTRU2's Uu AS, or WTRU1 may partition the task in sub-tasks and offload the subtask to WTRU2's AS. The offload decision may be made at the WTRU1 NAS, or WTRU1 AS, or at the WTRU collaboration layer, with inputs from the Uu layers. And although the AS of WTRU2 may be used to perform some tasks on behalf of WTRU1, it may still operate and perform its own procedures (e.g., procedures associated with WTRU2), but in this case it may be commanded by its own NAS for those procedures.

Prior to performing collaborative procedures, the WTRUs may exchange signaling to configure how they can coordinate, their respective capabilities and communication channels.

The collaboration configuration may include information such as available RATs; supported bands/carriers; Uu and SL capabilities; WTRU profile (WTRU type, power profile); collaboration capabilities, i.e., which procedures are supported to be coordinated, which information requests or sharing are supported.

A WTRU may send direct transmissions to the users in its group using PC5, using unicast, groupcast or broadcast transmissions. The transmissions may be periodic or aperiodic, depending on the content of the transmission.

The collaboration configuration may include the scheduling or occasions where the WTRU is expected to transmit or receive collaboration signaling, e.g., using periodic or dynamic scheduling or the signaling.

A WTRU may request information from another WTRU, sending the request over PC5-Collab and receiving a reply/report also on PC5-Collab, at the layer corresponding to the collaboration. In an example, the request may be a Layer 1 measurement of reference signals, exchanged between the PHY layers of the WTRUs; or a L3 measurement of reference signals, exchanged between the RRC layers of the WTRUs.

The request may be for a one-time report or can be triggering periodic/aperiodic reports (i.e., subscribing to a collaboration content). When a WTRU receives a request, it may reply with the information to report if available (and possibly after performing some related procedures). The WTRU may report to the requesting WTRU. When WTRUs are registered for specific periodic collaboration, a WTRU may periodically or be triggered by an information update report to the requesting/registered WTRUs.

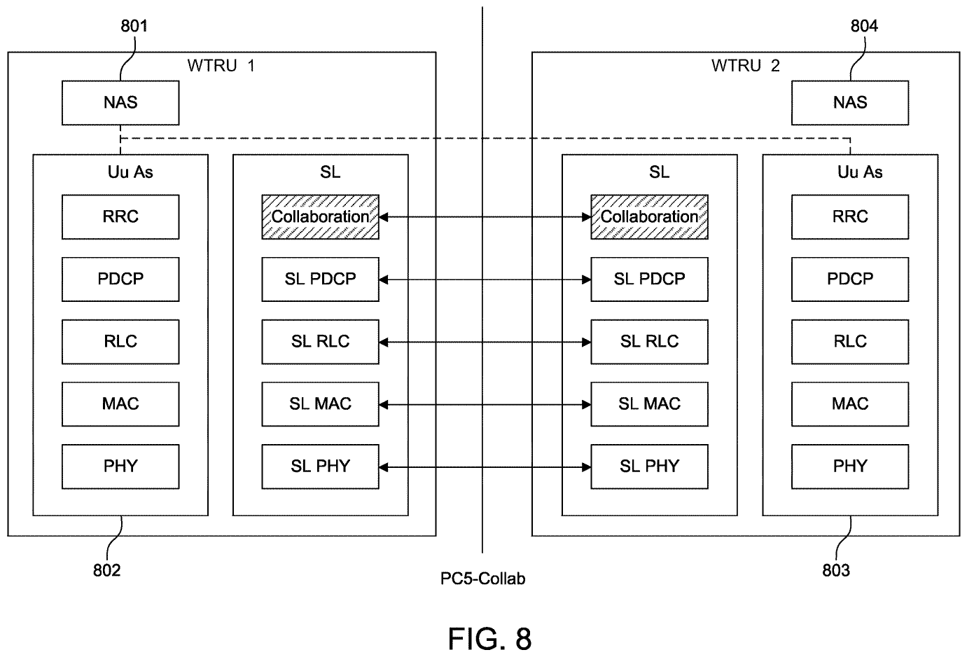

FIG. 8 illustrates a diagram of an example of control plane protocol stack for inter-WTRU assistance where one WTRU may use two separate NAS entities for control. In FIG. 8, the example of 3GPP sidelink inter-WTRU connection is used, where the NAS of WTRU1 801 may use the Uu AS of two different WTRUs 802 803 to perform a task. The NAS layer in WTRU1 801 may offload a task to WTRU2's Uu AS 803, or WTRU1 may partition the task in sub-tasks and offload the subtask to WTRU2's AS 803. The offload decision may be made at the WTRU1 NAS 801, or WTRU1 AS 802, or both of them, through a WTRU collaboration layer.

Comparing with the previously described architecture, in FIG. 7, one WTRU may also request the other WTRU to perform selected tasks on its behalf. The example of 3GPP sidelink for inter-WTRU connection is considered, where the NAS of WTRU 1 is using the AS of two different WTRUs to perform a task or uses the AS of another user to perform (part of) a task.

Similar operations may apply at different layers of the AS. Although the AS of WTRU2 803 is used to perform some tasks on behalf of WTRU1, it can still operate its own tasks and procedures and be commanded by its own NAS 804.

The cooperating WTRUs may first coordinate their NAS and AS configurations, e.g., available RATs, supported frequency and procedures. The NAS of the WTRU 1 may send a command to the AS of the WTRU2 using PC5-Collab and the WTRU 2 may perform the procedure or task requested. After completing the procedure or task, WTRU 2 may report the output to the NAS of WTRU 1. In one example, content of the reports and commands may be kept similar to the classic inter-layer communication within a single WTRU, but where the destinations are changed to the upper-layer (or lower-layer) of another WTRU.

In an alternative implementation, the NAS of WTRU 1 801 may also perform tasks using the AS of WTRU 2, but via communication through the NAS layer of WTRU 2 804, that would forward the task to its AS 803, either transparently or controlling the AS behavior for compatibility with the rest of the WTRU's task.

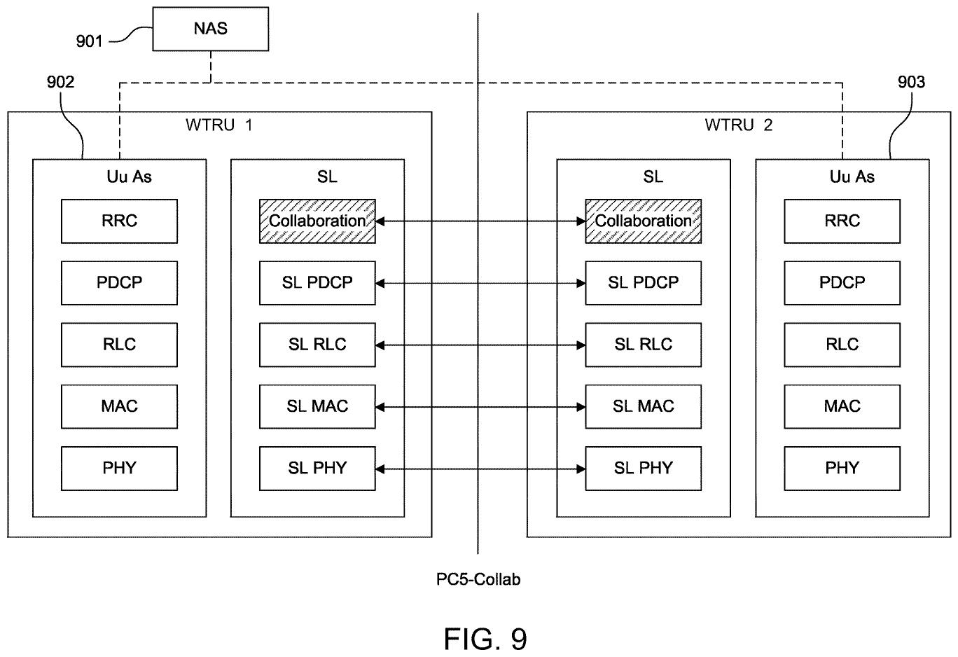

FIG. 9 illustrates a diagram of an example of control plane protocol stack for inter-WTRU assistance where one NAS entity may control multiple WTRUs' AS entities. In this example, a single NAS entity 901 is directly controlling WTRU1's AS entity 902 and WTRU2's AS entity 903. This can be extended to multiple WTRUS, as two WTRUs are used as an example for illustrations purposes. The NAS entity may be located within one of the controlled WTRU or in another WTRU. The communication between the NAS and AS layers that are not collocated is performed using inter-WTRU collaboration, e.g., PC5-Collab or other inter-WTRU links.

As illustrated in FIG. 9, a single NAS entity may be directly controlling AS entities of multiple WTRUs, similar conceptually to a dual connectivity. The NAS entity may be located within one of the controlled WTRU or in another WTRU. The communication between the NAS and AS layers that are not collocated may be performed using inter-WTRU collaboration, e.g., PC5-Collab or other inter-WTRU links.

The cooperating WTRUs may first coordinate their NAS and AS configurations, e.g., available RATs, supported frequency and procedures. The NAS of the WTRU 1 may send a command to the AS of the WTRU 2 using PC5-Collab and the WTRU 2 may perform the procedure or task requested. After completing the procedure or task, the WTRU 2 may report the output to the NAS of WTRU 1. For minimum interface and specification change, the content of the reports and commands may be kept similar to the classic inter-layer communication within a single WTRU, but where the destinations are changed to the upper-layer (or lower-layer) of another WTRU.

To perform collaboration between the WTRUs of a group, some information may be shared so that WTRUs know about each other's capabilities and status. This information may be used for group collaboration management, such as coordinator selection, task distribution or report sharing. Such information may include, for example:

WTRU capabilities such as frequency band support, RAT support, antenna/beam support, measurement capabilities etc. i.e., any information related to how the device can perform the measurement on the SSBs and cell search.

WTRU category, e.g., if the WTRU is a special kind of WTRU (e.g., NTN, RedCap, URLLC, Coordinator).

WTRU stored information. This indicates what the WTRU already found previously and may quickly find upon performing the stored information-based cell selection.

WTRU battery/energy status. This indicates whether the device needs to preserve its energy and should be avoided to perform tasks. E.g., power saving mode activated or not, power profile, remaining battery level.

WTRU location. Spatial information (e.g., absolute, or relative position, direction, speed) can be useful to determine the proximity between devices and so the redundancy of their measurements.

WTRU inter-connection in the group: inter-connected WTRU can easily share information directly and can update each other. Capabilities of the inter-connection such as the PC5 radio-interface, radio conditions, PC5 resource availability, etc.

WTRU collaboration capabilities, e.g., capabilities to supported being in a group, or being a coordinator, or which features, and procedures are supported to be distributed or offloaded.

WTRU service type and QoS requirements, e.g., what type of service is needed to be supported in the group for this user and what kind of requirement the WTRU expects to be assisted with for this group.

WTRU connection to the network status (in or out of coverage, RRC mode, Cell/PLMN ID, etc., if any).

Such information may be shared between the users, directly or via a coordinator, using PC5-Collab interface, between the AS (e.g., at the RRC level) or at the NAS level depending on the collaborative procedures. Such information may be exchanged during or after the PC5 link establishment between the devices, when exchanging configuration or capabilities about devices. Some of the information may further be shared between the users, periodically or on-demand, to keep updated the devices in the group, e.g., the battery status, location.

Regarding primary or coordinator user selection, in a group of WTRUs, one WTRU may take the role of coordinator (or manager, or primary) WTRU. The user device may take the responsibility to coordinate the WTRUs of the group to perform tasks jointly or to perform tasks on behalf of the other WTRUs in the group. The coordinator WTRU thus may need to have the capabilities to perform the collaboration as well as a strong connectivity with the WTRUs in the group.

Note that the Coordinator WTRU also may provide the WTRUs of the group with connectivity to the network (e.g., as a relay or gateway) but it is not mandatory.

Below are described embodiments, including methods and structures to enable the selection of a coordinator WTRU within a group to select the WTRU that could best coordinate the group.

Several embodiments are described to select the group coordinator.

In one embodiment, some devices may be specialized for WTRU collaboration and hard-coded or (pre)configured to be coordinator WTRUs. Thus, when included in a group or when connecting with other WTRUs, these devices are automatically assumed (or selected) to be the coordinator. Such a WTRU can announce its capability and role upon connection establishment in the SL, during capability exchange for example.

This type of WTRU can for example be placed in selected locations where some specific service requirements are hard to achieve with regular un-collaborative WTRUs, e.g., for a dense WTRU scenario, assisting the WTRUs and network to provide the service and QoS required.

In one example, when a group of users is being configured in a collaboration communication group, the assisting WTRU becomes the coordinator/primary WTRU, while the assisted WTRU (s) are the secondary WTRU (s).

In another example, the service or application for this group is configured by the application layer that designates the device to be a coordinator, e.g., the device that initiates the service or a more capable device. The configuration of the group includes the coordinator configuration and is shared between the users.

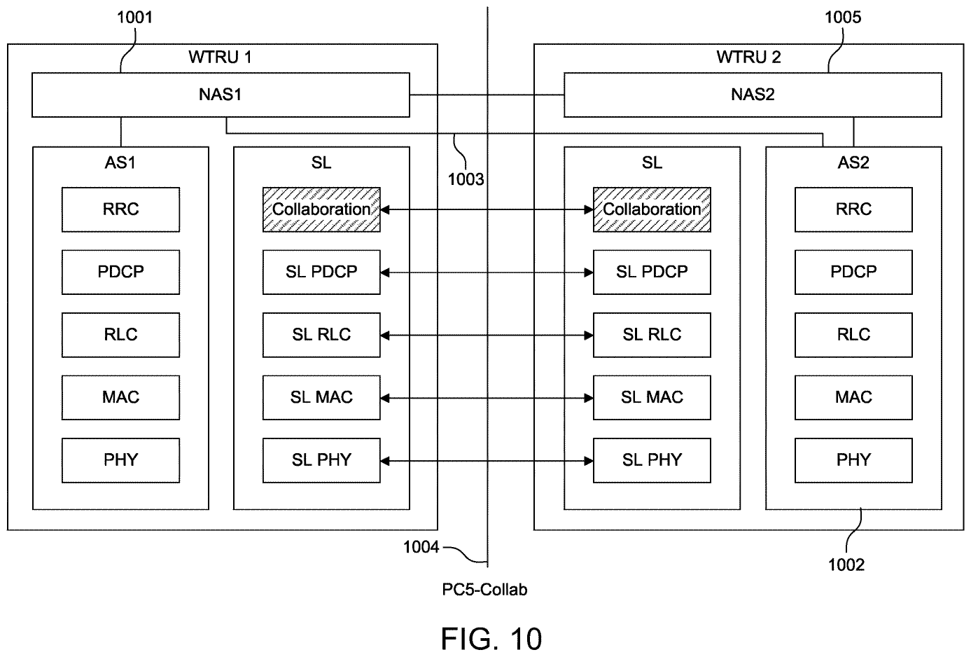

FIG. 10 illustrates examples of the logical interfaces that may be used by the solutions. In terms of logical functionality, NAS1 1001 may communicate via an interface with AS2 1002. To execute this communication, the PC5 interface is used: NAS1 1001 may send a command to AS2 1002 using the logical interface NAS1-AS2 1003, via PC5-Collab 1004. WTRU2 may then perform the procedure or task requested and, after completing the procedure or task, WTRU2 may report the output to NAS1 1001 using the logical interface NAS1-AS2 1003, via PC5-Collab 1004. The content of the reports and commands may be kept similar to the typical inter-layer communication within a single WTRU, but where the interfaces may be changed (e.g., the destinations may be changed to the upper-layer (or lower-layer) of another WTRU) and the information is encapsulated to be sent to the peer WTRU.

In an alternative implementation, NAS1 1001 may perform tasks using AS2 1002, but via the NAS2 1005. NAS1 1001 may send a request to NAS2 1005, and NAS2 1005 may send the task request to AS2 1002 (e.g., either transparently or controlling AS2 behavior for compatibility and coordination with the rest of the WTRU's task).

Optionally, a collaboration layer may be leveraged to send tasks requests and reports between the WTRUs

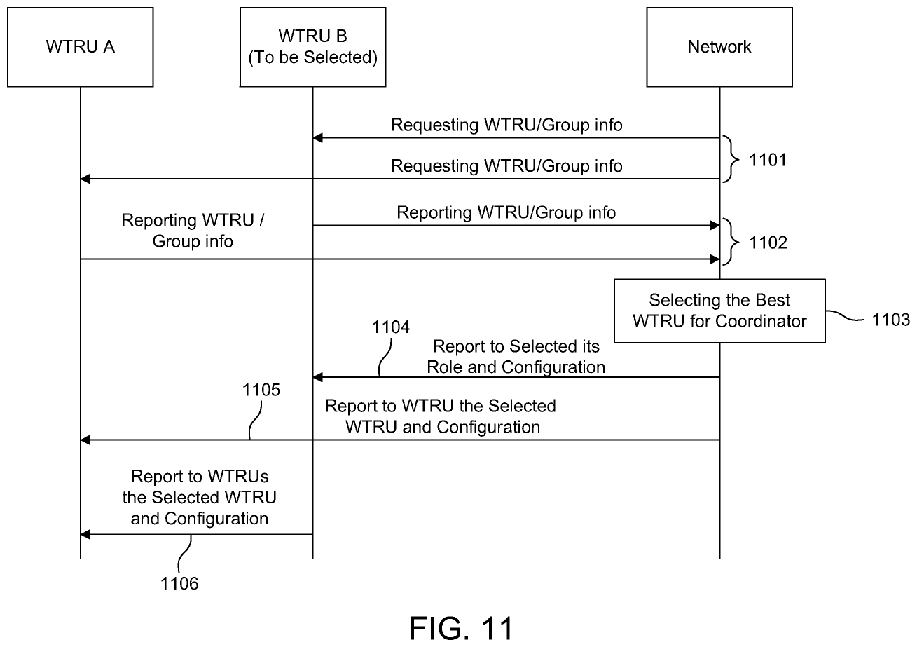

FIG. 11 illustrates a call flow of an example of network-based WTRU coordinator selection

In another example, the network performs the selection of the coordinator WTRU for the group. Note that the WTRUs may communicate with the network directly (e.g., via Uu RRC, DCI, or paging messages for IDLE/INACTIVE UEs) or through relays.

Referring to FIG. 11, the network may request information or updates on the group and WTRUs in the group 1101. The WTRUs in the group may report their information to the network 1102.

Various information may be used to select the coordinator WTRU. In particular, the WTRU capability to perform the collaboration tasks, Uu capabilities, SL capabilities, Uu link quality (e.g., Uu RSRP), SL connection status and SL RSRP to other devices in the group, number of hops to other devices, Service associated with the group and its QoS, Cell ID of the WTRUs, connection states, or PLMN ID.

Information pieces about WTRU configuration and setup may be exchanged during connection setup or through RRC. Dynamic information such as RSRPs or connectivity status may be obtained from reports such as WTRU CSI reports or based on the request by the network.

The network selects the coordinator WTRU based on reported WTRU information 1103.

The selection may be based on the WTRU capability of supporting inter-WTRU collaboration.

WTRUs may be ranked according to a score that is computed for each WTRU. The score/priority may be based on the WTRU information criteria that may be computed directly by the network, or by WTRUs, autonomously. The WTRU with the highest rank/score/priority may be selected to be the coordinator. The scores may be shared by the network or between the WTRUs to find the highest score WTRU.

In an example, the score is based on the WTRU with the strongest Uu RSRP to be the WTRU coordinator, to ensure reliable communication between the network and the coordinator.

In another example, the score may be based on maximizing the link quality and minimizing the number of hops between the users can be a criteria, to maximize the reliability and minimize delay between the WTRUs.

In another example, the score may be based on the energy status of the WTRU, where low-energy devices may be avoided.

In another example, the score may be based on the number of WTRUs that are served by the same cell or same PLMN.

In another example, the score may be based on the geographical location (absolute or relative) or speed of the devices.

The network may send an indication to the selected WTRU informing about its coordinator role 1104. The network may assign collaboration tasks and configuration to the coordinator.

The network may also indicate the coordinator WTRU to the other WTRUs of the group 1105. Alternatively or in complement the coordinator WTRU may indicate its status to the WTRUs in the group, via inter-WTRU communication, e.g., using PC5-Collab 1106.

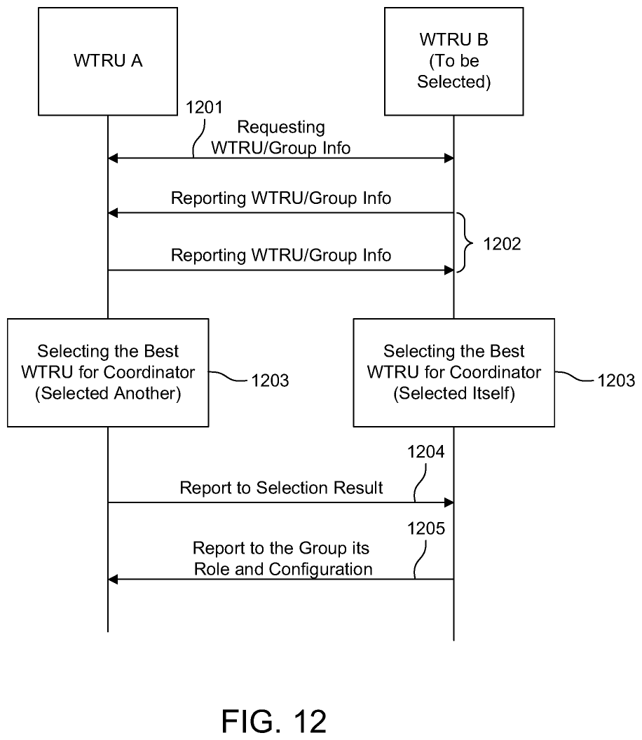

FIG. 12 illustrates a call flow of an example of a WTRU-based coordinator selection.

In this example, the coordinator WTRU is selected between the WTRUs autonomously. The communication between the WTRUs can take place for example over PC5-Collab, e.g., at the RRC level.

A WTRU, WTRU B, may request WTRU information or an update on WTRU information to the WTRUs in the group 1201. The WTRUs in the group report their information to the network. Similar information may also be exchanged between the WTRUs 1202 and between WTRUs and network in previous option.

Some aspects of the WTRU information may be exchanged during WTRU direct communication setup or grouping setup, such as the capabilities; or may be exchanged more dynamically, such as link conditions.

In parallel, WTRUs select the coordinator WTRU based on reported WTRU information 1203. Similar rank as previously described may also be used here.

The WTRUs may share the results with each other, indicating the selected WTRUs and/or ranking results 1204. The selected WTRU may further indicate itself as the coordinator, with additional collaboration configuration 1205.

When establishing the ranking of the potential coordinators, WTRUs may base their computation on the same information input from other users, which may result in the same ranking. However, if the information shared is not correctly synchronized (e.g., data loss, lack of connectivity, outdated information) the results may be different and multiple WTRUs may be selected for coordinators. In this case, and if the group is configured to only support a single coordinator, the selected coordinators may exchange their information with each other and perform a limited ranking comparison to down-select the final coordinator. The result of this converging selection is shared with the WTRUs in the group (similar to 1204).

Although embodiments of solutions focus on selecting one coordinator for a group, it is also possible for a group to have multiple coordinators. Different coordinators in a group may handle different managing tasks, or handle subsets of the WTRUs in the group. One example is in the case of a group of WTRUs for a service or application where the WTRUs belong to different operators or are not in proximity and associated with different cells, and there may be one coordinator defined, e.g., per PLMN, per cell, or based on geographic proximity.

Regarding multi-WTRT low-layer aggregation for IDLE/INACTIVE measurements, in some examples, some of the devices may be limited by their capabilities, power, energy, or connectivity to access the network like regular devices. To increase the performance of these WTRUs, WTRUs can be “aggregated” where one “aggregated” WTRU assists another “anchor”.

The aggregated WTRU may assist the anchor WTRU by sharing its hardware and processing to perform joint signal reception, e.g., where low-layer (PHY-MAC) of the WTRUs are jointly performing measurement or sensing.

In this disclosure is disclosed the measurements for the RRC IDLE and INACTIVE mode. For cell (re)selection and PLMN selection, the WTRUs are measuring the cell's SS-RSRP on the secondary synchronization signals of the SSB.

Through the aggregation link, the WTRUs may exchange their measurements, and the RSRP/RSRQ of a aggregated/joint-processing reception may be evaluated. The exchange of the measurements may be performed between the Uu stacks of the WTRUs, at the PHY layers, MAC layer or RRC layer level, depending on the exchanged data, and may be beam-specific in the case where the cell uses multiple beams. The configuration of the aggregation may include which measurements are shared between the WTRUs and how they are processed, e.g., through network configuration or through SL configuration.

Solutions for the selection of an aggregated WTRU are described. This selection may be performed independently of the cell or PLMN selection. An anchor may select the aggregated WTRU. In one example, the aggregator role may be static, e.g., based on provisioning, network configuration, hardware or deployment choices.

Some devices may be specialized for WTRU aggregation and hard-coded or (pre)configured to be aggregated WTRUs (at least for specific anchor WTRUs). When connecting with other WTRUs, these devices may automatically be assumed (or selected) to be the aggregator. Such a WTRU may announce its capability and role upon connection establishment in the SL, during capability exchange, for example. There is a-priori agreement that a device with those capabilities may perform as an aggregator. A selection per-se is not needed.

In one example, a static WTRU aggregator may be placed in a selected location where specific service requirements are difficult to achieve with regular unaggregated WTRUs, e.g., for coverage edges.

In another example static WTRU aggregator may be in a location where multiple devices are being used for a given application, e.g., VR/XR, mounted multi-sensor or personal internet of things (PioT) devices. In this case, a more capable device (e.g., a smartphone) may assist secondary devices (e.g., glasses, wearables, cameras, etc.) of a given user. When a group of users is being aggregated in an aggregated/anchor relationship, the aggregated WTRU may become the coordinator/primary WTRU, while the anchor(s) WTRUs are the secondary WTRUs. Optionally, the network may assign an aggregator, e.g., to improve anchor WTRU performance

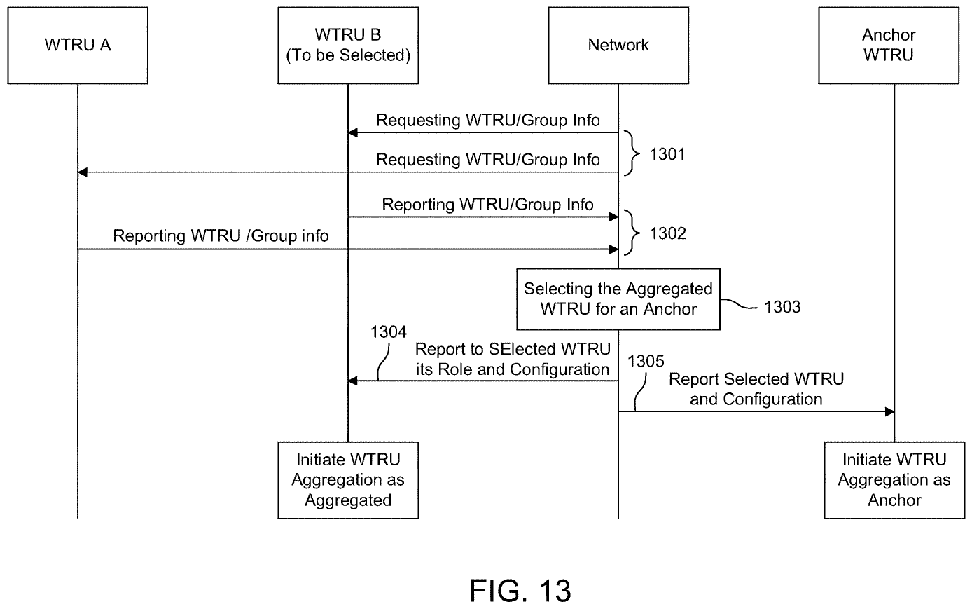

FIG. 13 illustrates a call flow of an example of network-based aggregated WTRU selection.

Referring to FIG. 13, the network may perform the selection of the aggregated WTRU for an anchor WTRU. This aggregation, managed by the network, may be triggered, for example, when the WTRU is moving out of coverage or where the coverage may limit its expected service. The aggregated WTRU may assigned to assist.

The network may request information or updates on the group and WTRUs in the group 1301. WTRUs in the group report their information to the network 1302.

Various types information may be used to select the aggregated WTRU, such as describe in previous paragraphs. In particular, the WTRU capability to perform the aggregation tasks, its Uu capabilities, SL capabilities, Uu link quality (e.g., Uu CSI or RSRP), SL connection status and SL RSRP to other devices in the group, number of hops to other devices, service associated with the group and its QoS, cell ID of the WTRUs, connection states, or PLMN ID.

Information regarding WTRU configuration and setup may be exchanged during connection setup or through RRC. Dynamic information such as RSRPs or connectivity status may be obtained from reports such as WTRU CSI reports or based on the request by the network.

The network may select the aggregated WTRU (s) based on reported WTRU information, targeting the anchor WTRU 1303.

The selection may be based on the WTRU capability of supporting WTRU aggregation, but other criteria can be also be leveraged. WTRUs can be ranked according to a score that is computed for each WTRU. The score/priority may be based on the WTRU information criteria that can be computed by the network. The WTRU with the highest rank/score/priority may be selected to be the aggregated WTRU. The scores may be shared by the network or among the WTRUs to find the highest score WTRU.

In an example, the score may be based on targeting the WTRU with the strongest Uu RSRP, to ensure reliable communication between the network and the aggregated WTRU.

In another example, the score may be based on the WTRU with the strongest SL RSRP with the anchor WTRU or based on the inter-WTRU communication interface type.

In another example, the score may be based on the geographical location (absolute or relative), and optionally velocity of the devices.

In another example, the score may be based on the energy status of the WTRU, where low-energy devices should be avoided.

The score may also be based as a combination of multiple of these example metrics.

The network may indicate the aggregated WTRU of its role, and provide configuration 1304, e.g., the anchor WTRU ID, possibly scheduling resources for communication with other WTRUs or with the network, aggregation tasks, such as assisting for cell and PLMN selection or assisting as a relay.

The network may also indicate, to the anchor WTRU, the selected aggregated WTRU and its configuration 1305. In another example, the WTRU may select autonomously, based on information received.

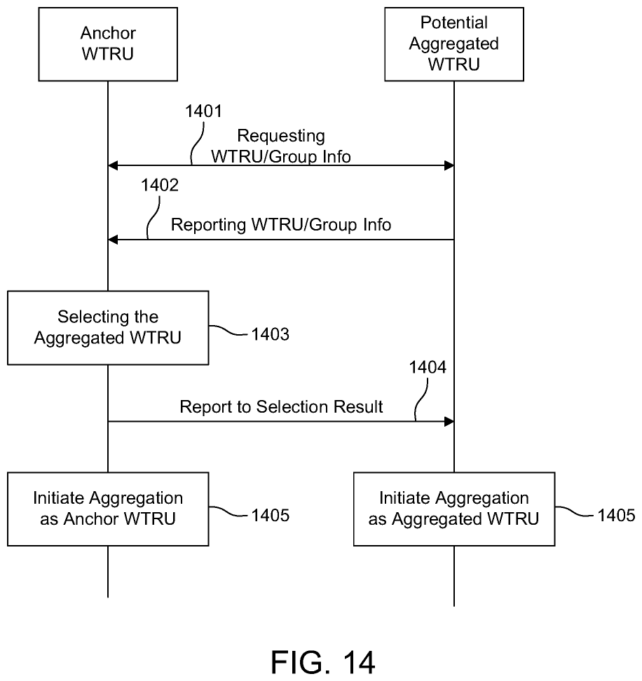

FIG. 14 illustrates a call flow of an example of autonomous aggregated WTRU selection.

The communication between the WTRUs may take place for example over PC5-Collab, e.g., at the RRC level. Multiple WTRUs may be contacted by the anchor WTRU simultaneously or sequentially, and the anchor may perform a selection among the reported replies.

An anchor WTRU may request WTRU information from a potential aggregated WTRU 1401, requesting for updated information such as Uu connection and status (e.g., Uu RSRP, cell ID), and its capabilities. The request may also include the anchor WTRU information, including information that may be used to filter the report of the aggregated WTRU. The anchor WTRU may include its own information.

A potential aggregated WTRU is a WTRU that may perform the aggregation functionality. It may be a specific WTRU or a set/all WTRUs in the group. It may be known a priority by the anchor WTRU, as part of a configuration. Or it may be determine during a discovery phase.

The potential aggregate WTRU may report its status and updates information according to the request 1402.

Some types of WTRU information may be exchanged during WTRU direct communication setup, grouping setup, such as the capabilities; or may be exchanged more dynamically, such as link conditions.

The anchor WTRU may select its aggregated WTRU based on reported WTRU information 1403. Similar rank models as previously described may also be used here. The anchor WTRU may report the selection to the aggregated WTRU 1404.

The anchor WTRU may share the results with each other, indicating the selected WTRUs and/or ranking results and the configuration of the aggregation. Configuration parameters may include one or more of: anchor WTRU ID, potential cell ID, coordinator WTRU ID, scheduling resources to communicate with each other, aggregation tasks, such as assisting for measurements, assisting for cell and PLMN selection or assisting as a relay.

The WTRUs may initiate (or activate) their roles in the aggregation, as anchor and aggregated WTRUs 1405.

Although the solutions described focus on selecting one aggregated WTRU for the anchor, it is also possible for the anchor to have multiple aggregated WTRUs.

Regarding a configuration and aggregated measurement procedure, measurements follow a succession of processing, from signal sampling to Layer 3 values. In a general embodiment, two devices in aggregation may exchange their measurements for joint processing at different stages. This implies that a first WTRU may preprocess a received signal with parts of the processing usually required, transmit the preprocessed signal to a second WTRU, and the second WTRU may complete the processing, using both its own received signals and the preprocessed signals. The processing stage at which the measurement signal is transferred to the other device may be configured and different options may be possible.

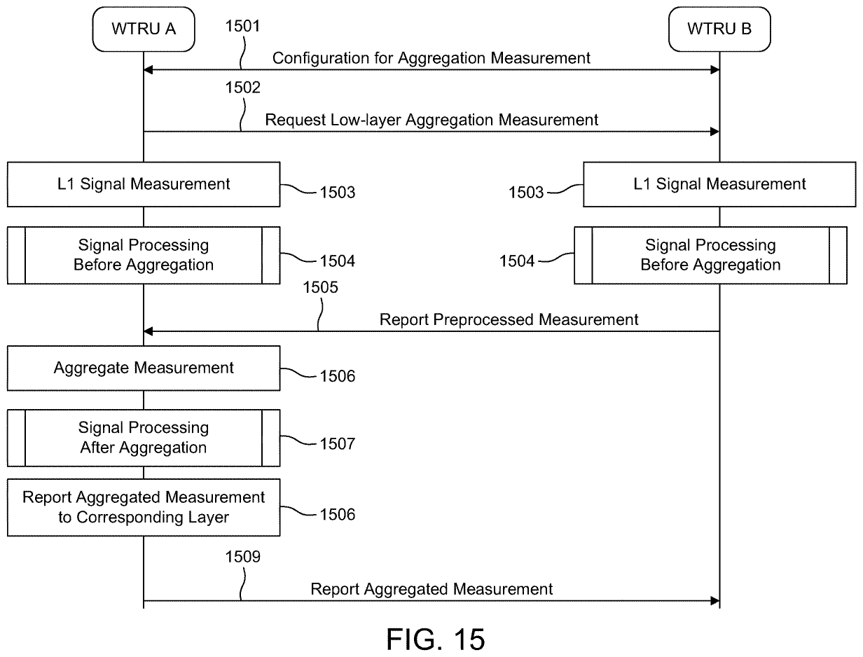

FIG. 15 illustrates a call flow of an example of a procedure for multi-WTRU aggregated measurement. Without loss of generality, two WTRUs are used in this example.

WTRUA and WTRUB may interchangeably be the anchor WTRU or the aggregated WTRU, depending on which WTRU triggers the measurement and/or which WTRU performs the procedure/decision related to this measurement.

Although is the example is described for two WTRU, it is possible to duplicate/parallelize the WTRU behaviors to have an aggregation of multiple WTRUs measurements.

In a first step, WTRUs in aggregation may exchange their configuration for the aggregated measurements 1501.

The configuration may include the supported aggregation measurements and capabilities, e.g., what type of measurement and processing can be performed for the aggregation (RSRP, RSRQ, RSSI, etc.), RS, and for which procedures.

The configuration may include exchanged data content, e.g., at which processing step the measurement is exchanged.

The configuration may include processing requirements before exchange, including the parameters and methods for the preprocessing steps or performance requirements for the preprocessing steps.

The configuration may include measurement object to be considered, e.g., which reference signals are measured, for which metric and procedure.

The configuration may include configuration of the aggregated measurements, e.g., whether they are dynamic (on-demand) or periodic.

The configuration may include the measurement quantities to be reporting, including for example: raw measurement samples (“A”, FIG. 2, 201), Layer 1 filtered measurements (“A1”, FIG. 2, 203), L3 filtered beam measurements (“E”, FIG. 2, 212), cell quality (“B”, FIG. 2, 205), filtered cell quality (“C”, FIG. 2, 207) or RSRP (“D”, FIG. 2, 209). This information may also be sent in the request to perform the aggregated measurement 1502, allowing for a more dynamic selection of the measurement quantities to be reported.

WTRU B may receive a request to perform the aggregated measurement 1502. The request may be received from another WTRU in the aggregation or from a coordinator WTRU or the network. Alternatively, the measurement may be triggered intern ally, by the WTRU itself, e.g., if performing a configured periodic/semi-static measurement.

The request may include or refer to the configured measurement to be performed, e.g., the measurement object or the received signal (RS); as well as the timing for the measurement, reporting scheduling, and conditions.

WTRUs may perform their measurements according to the configuration 1503, e.g., on the SSS corresponding to the configured timing. The sample timing may be used to synchronize the measurements between devices to be able to compute a joint reception. The configuration/request may indicate to the WTRUs which SSS to report, so that WTRUs may synchronize and perform measurements on the same samples. Measurements may be beam specific if the network uses beam-based SSB.

WTRUs may obtain their input for measurement processing, corresponding to the “A” measurements in FIG. 2, for example A: measurements (beam specific samples) internal to the physical layer.

WTRUs may perform the configured processing on the measurements 1504. The WTRUs may be configured to perform the same steps of measurements, although the processing method or parameter may be different, depending on WTRUs implementation, performed measurement and configuration.

In an embodiment, the WTRUs may not perform measurement-related processing to the measurement samples.

In another embodiment, the WTRUs may perform only the Layer 1 filtering processing to the measurement samples.

In yet another embodiment, the WTRUs may perform some of the Layer 3 (RRC configured) processing to the measurements, such as the beam consolidation, beam selection, or L3 beam filtering.

The WTRUs may still perform the remaining measurement processing in parallel with the following steps, e.g., to have the completed measurement for itself, or to be able to perform evaluation on refined (preprocessed) measurements.

WTRU B may transmit the preprocessed measurements to WTRU A 1505, according to the configured reporting steps, and using the configured scheduling/resources.

Depending on the configuration, WTRU B may report raw measurement samples (“A”, FIG. 2, 201), Layer 1 filtered measurements (“A1”, FIG. 2, 203), L3 filtered beam measurements (“E”, FIG. 2, 212), cell quality (“B”, FIG. 2, 205), filtered cell quality (“C”, FIG. 2, 207) or RSRP (“D”, FIG. 2, 209).

When measuring multiple sources of signals, WTRU B may sub-select which measurements to report, to remove signals with too low strength. The signal requirements may be configured, e.g., an RSRP threshold or signals passing the beam selection, and the thresholds can be set differently for different aggregation methods.

WTRU A may combine its own preprocessed measurements with the received ones 1506.

In an embodiment, WTRU A may combine the measurements samples by adding the samples directly or adding the absolute power contribution value of each sample 1506.

In another embodiment, WTRU A may combine the measurements samples by adding the filtered samples directly or adding the absolute power contribution value of each sample 1506.

In yet another embodiment, WTRU A may combine the measurements, e.g., by adding the RSRP values together (in the linear domain); for RSRQ values, the RSRP and RSSI values may be first combined separately then compute the combined RSRQ based on combined RSRP and RSSI values 1506.

WTRU A may resume the processing of the measurements, if any 1507.

In an embodiment, WTRU A may resume and perform the Layer 1 filtering and the RRC processing.

In another embodiment, WTRU A may resume and perform all the RRC processing.

In yet another embodiment, WTRU A may resume and perform the remaining RRC processing.

WTRU A may report the aggregated measurement result to the corresponding layer or entity, depending on the originating request, including the aggregation configuration or aggregated WTRUs participating in the measurement 1508.

WTRU A may report the measurement result to WTRU B, including the aggregation configuration or aggregated WTRUs participating in the measurement 1509.

Regarding embodiments of the device receiving the measurement request for the aggregation, a WTRU may exchange, with another WTRU, configurations and capabilities for the aggregated measurements, such as processing L1 filtered measurements, to measure a cell's RSRP. When triggered to perform a measurement, the WTRU may transmit the aggregated measurement request to another WTRU in the aggregation, e.g., using SL, including the object to be measured and the timing and preprocessing. The WTRU may perform its measurement and preprocessing steps according to the configuration and receives the preprocessed measurement from the other WTRU. The WTRU may aggregate the measurements, e.g., by adding signal strengths of the received and measurements signals. The WTRU may resume the processing to finalize the measurement. The WTRU may send the measurement report to the entity requesting the measurement and to the devices participating in the measurement.

Regarding embodiments of the device transmitting the measurement request for the aggregation, a WTRU may exchange, with another WTRU, configurations and capabilities for the aggregated measurements, such as processing L1 filtered measurements, to measure a cell's RSRP. When receiving a request to perform a measurement or triggering a measurement, e.g., due to periodic measurement configuration, the WTRU may perform the requested measurement and preprocessing steps according to the configuration. The WTRU may sub-select part of the measurements for reporting. The selection may be based on signal strength of the measurement and configured thresholds. The WTRU may transmit the preprocessed measurement from the other WTRU based on the configuration. It further receives the aggregated measurement result from the aggregating device.

Processing steps and processing parameters for measurement aggregation are described.

In the cases where the measurements are exchanged after the Layer1 filter, the filtering may give a more stable measurement of the SSS, although neither the filtering itself nor the measurement input are constrained and may be different from one device to another.

One embodiment includes adding a standardized Layer1 filter in the case of aggregated/exchanged measurements, or having a Layer1 filter that may be configured by the network or between the WTRUs during the aggregation configuration phase. This filter configuration may, for example, be a list of coefficients to be applied in the frequency and time domain on the L1 samples. This configured/standardized filter may be used instead of the implementation specific L1 filter in the case of aggregated measurements 1504.

In one embodiment, a WTRU is configured with a Layer 1 filter method and parameter (e.g., filter coefficients) that may be applied for aggregation measurement. When an aggregated measurement is triggered by the WTRU or requested to the WTRU, the WTRU may use the configured Layer 1 filter, based on the configuration (and/or from the request). Then, it may transmit the Layer 1 filtered measurement to another WTRU.

When processing the aggregated measurement samples, the device may proceed with the Layer 3 processing, the WTRU beam consolidation/selection, Layer 3 Beam filtering, Layer 3 filtering for cell quality, beam selection for reporting, evaluation of reporting criteria. The RRC parameters typically correspond to a classic measurement case that may not necessarily be ideal for aggregated measurements.

In one example, a dedicated set of RRC parameters for the aggregation cases is provided to the devices. The set of parameters may be configured by the network or configured between the WTRUs (e.g., using PC5-RRC).

For example, the thresholds used in the criteria for beam consolidation, selection and reporting criteria may be adapted in the case of the aggregation, using a dedicated criteria that may be added in the RRC parameters, or using offsets parameters that may be added to the original criteria.

Layer 3 aggregated filter coefficient: As another example, the Layer 3 filter is typically configured using filterCoefficient, FilterCoefficientRSRP, or FilterCoefficientRSRQ for the corresponding measurement quantity of the ith QuantityConfigNR in quantityConfigNR-List, and I is indicated by quantityConfiglndex in MeasObjectNR; a new and similar parameter, Layer 3 aggregated filter coefficient, Aggregation-filterCoefficient, may be jointly configured in the QuantityConfigNR to be used for measurement aggregation. Alternatively, a configured filterCoefficientAggregationOffset may be configured and applied to the filter coefficients when the aggregation is used.

An example of aggregation IE in RRC may be as (using ASN.1 encoding) for Layer 3 aggregated filter coefficient:

Aggregation-QuantityConfigRS ::= SEQUENCE {
ssb-FilterConfig Aggregation-FilterConfig,
csi-RS-FilterConfig Aggregation-FilterConfig
}
Aggregation-FilterConfig ::= SEQUENCE {
Aggregation-filterCoefficientRSRP FilterCoefficient,
Aggregation-filterCoefficientRSRQ FilterCoefficient,
Aggregation-filterCoefficientRS-SINR FilterCoefficient
}

In one embodiment, a WTRU may be configured (by the network or by another WTRU) with an aggregation specific set of configurations for Layer 3 filter (e.g., filter coefficients). When an aggregated measurement is performed by the WTRU, the WTRU may use the configured Layer 3 filter for aggregation. Then, it may resume the remaining processing steps of processing.

Regarding accuracy adaptation, another element to consider in the aggregation for joint processing based on the measurements performed at different devices is the accuracy of the measurement. In an embodiment, when a measurement is received, the device may apply an offset to the measurement in order to take into account some potential accuracy issues.

As an example, the NR specification specifies the accuracy requirement for the SS-RSRP to ±4.5 dB and SS-RSRQ to ±2.5 dB in normal conditions for FR1 intra-frequency band measurements. This requirement may change depending on the carrier, band, operation mode (e.g., CA/DC), inter vs intra-frequency measurements etc. Also, the requirement for a given configuration may be different when the device is in “extreme conditions,” which is when the temperature is outside of the +15 °C to +35 °C range, as is known, where the accuracy goes to ±9 dB and to ±4 dB for the SS-RSRP and SS-RSRQ respectively.

Thus, a device receiving another WTRU's measurement may know its configuration and status to correctly adapt with the determined accuracy.

In one embodiment, the accuracy required for the aggregation may be specified as an independent configuration, e.g., that the WTRUs may use when in aggregation; or as a configured requirement in the aggregation configuration between the WTRUs, e.g., during the connection configuration or RRC configuration. The configuration may be measurement specific and be dynamically indicated, e.g., during the measurement request. The configured accuracy requirement may be used by the WTRU to determine which processing to use, e.g., determine the L1 filter or L3 filter to apply from a set of preconfigured filters.

In one embodiment, a WTRU may configured to perform measurements for aggregation. The WTRU may receive a measurement configuration from another WTRU, including an indication related to the accuracy requirement. The WTRU may select and apply the preprocessing methods (e.g., the L1 and L3 filters) from lists of configured methods, the selected methods corresponding to the configured accuracy requirement. The WTRU may report the preprocessed measurement, optionally with the methods or accuracy requirements applied to it.

In another option, the WTRU reporting a measurement may report the accuracy of the measurement, either by reporting an absolute accuracy value (based on the specification tables, or based on the device implementation knowledge); or by indicating the configuration in which the measurement was done (i.e., intra vs inter-frequency measurement, frequency range, normal vs extreme condition, etc.) and the receiving device determines the corresponding accuracy based on known specification tables.

Based on the accuracy expected from a measurement, the device may apply an offset to the received measurement. As an example, the offset can be set to half of the accuracy value (e.g., if the accuracy requirement is ±4 dB, a −2 dB offset may be applied to the measurement).

In one embodiment, a WTRU may be configured to receive (pre)processed measurements for aggregation. The WTRU may receive a measurement from another WTRU as well as an indication related to the accuracy requirement followed by the other WTRU. The indication may be, for example, whether the measurement is performed under extreme conditions or regular conditions; or explicitly, an accuracy range. The WTRU may determine and apply an offset to be applied to the received measurement based on the accuracy indication.

Regarding low-level information sharing, in another embodiment, the users may be sharing information about low-layer processing, to assist each other in finding and processing the relevant signals. Instead of (or in addition to) exchanging measurements, they may exchange information, e.g., to help the synchronization on selected cells/frequency.

In one example, a WTRU, after performing some measurements of the spectrum, may transmit to a requesting WTRU some frequency and timing indications that help identify and synchronize with a synchronization signal. Information such as absolute or relative timing indication to find the synchronization signal, correlation pic information, timing and frequency location of SSB bursts, for one or multiple beams. Such information may be used by the assisted WTRU to find the cells more efficiently, and may reduce the radio monitoring and processing time to what is necessary only.

Measurements performed with low-layer aggregation in IDLE and INACTIVE modes.

In support of cell selection or reselection with low-layer aggregation, the aggregation may already be in place and active, and a cell selection procedure may be performed for the anchor WTRU. The decision may be made at the anchor itself or at the aggregated WTRU.

In a second embodiment, the cell (re)selection may be jointly performed with the aggregation selection. An aggregation-base cell reselection may be needed. For example, the cell (re)selection procedure may be adapted so that the selection criterion and ranking take into account that the WTRU may be using aggregated measurements.

Regarding cell (re)selection for already-aggregated WTRUs, it is disclosed below how, according to an embodiment, a cell (re)selection procedure can be performed using low-layer aggregated WTRUs. It is assumed here that the anchor WTRU and the aggregated WTRU(s) are already grouped with each other.

Two cases are presented here, where the selection decision is performed either at the anchor WTRU side or at the aggregated WTRU side.

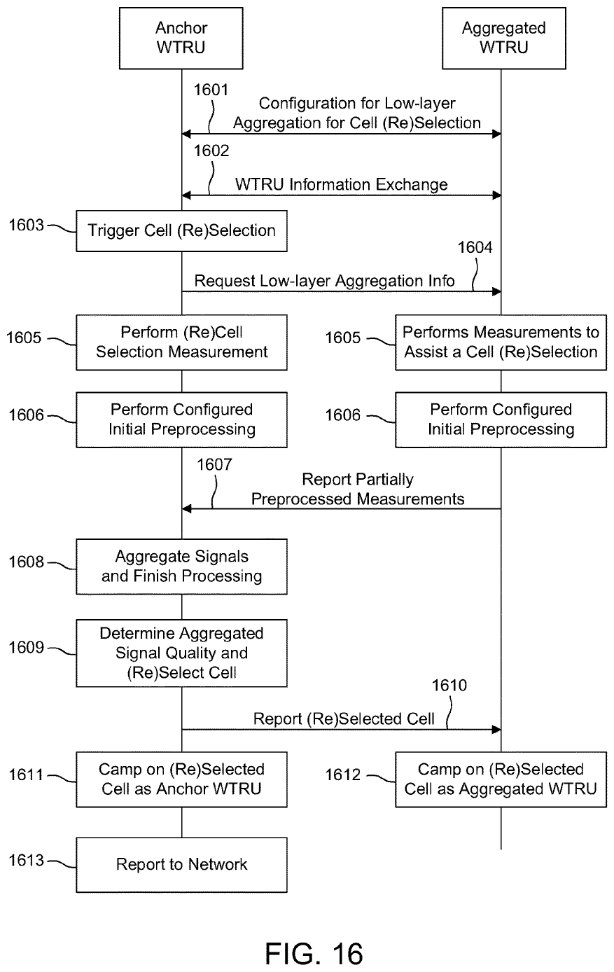

FIG. 16 illustrates a call flow of an example of lower-layer aggregation for cell (re)selection performed by an anchor WTRU.

In the case of cell (re)selection at the anchor WTRU side, the anchor WTRU may initiate a cell selection procedure and receive the measurement information from the aggregated WTRU (s) to evaluate the cell quality under low-layer aggregation. The anchor WTRU that initiates the cell selection procedure may apply the cell selection procedure and criteria, where the criteria may be adapted for an aggregated based criteria, as mentioned above.

Although the procedure is described for a single aggregated WTRU, it is similarly applicable to multiple aggregated WTRUs, duplicating the exchanges.

The anchor WTRU and aggregated WTRU may exchange the configuration for the low-layer aggregation for the cell selection 1601.

The configuration may be a pre-configuration, and/or a configuration exchanged between the WTRUs, e.g., during the aggregation or grouping setup configuration, and/or during the SL connection configuration. The configuration may be transmitted using the SL discovery setup signaling, and/or the PC5-Collab or SL RRC signaling. The configuration may also be obtained through the network through system information, e.g., using a new dedicated SIB for aggregation configuration.

The configuration may include a set of parameters that may replace the regular cell selection procedure parameters, and applied when the cell selection is performed using the aggregation.

The configuration may be WTRU specific and/or service specific, so that the criteria may be adapted to the devices and their usage.

The configuration may include the timing for the procedure (e.g., requests and replies). For instance, the requests may be transmitted on selected resources or occasions, to be monitored by the WTRUs in the group configured and supporting collaborative cell selection. The scanning reports may also be configured to be transmitted on selected resources or occasions and be configured with a maximum timing requirement to send their report after the reception of a request.

The configuration may include the required measurements to be done by the aggregated WTRUs, i.e., RSRP and RSRQ based on the SSS, and the time validity of the measurements. In one embodiment, the measurements and reports may be configured to be a one-time request/report. In another embodiment, the measurements may be activated and reported regularly, periodically, or based on an event.

The configuration may include the computing method and parameter/offset values required for the aggregated cell selection criteria and measurements to be used by the WTRUs in the subsequent steps.

The anchor WTRU and aggregated WTRU may exchange WTRU information 1602. Some information may be exchanged at the configuration of the aggregation, and some may be regularly updated. 1601 and 1602 may be done simultaneously, using different messages, or together, using the same message, or in reverse order.

Cell (re)selection may be triggered by the anchor WTRU 1603. The anchor WTRU may verify that it is configured to perform low-layer aggregation cell (re)selection, and with which WTRU(s).

For example, the anchor WTRU may request collaborative cell (re)selection when its battery level is below a configured threshold; or when the WTRU is at the cell edge or failed to select a suitable cell in a previous attempt; or when there is a change in the WTRU collaboration group (e.g., a new assisting WTRU), after a (collaborative) PLMN selection, after turning on the main radio receiver, etc. The cell (re)selection procedure may also be triggered by the setting of an aggregation group or can also be triggered by the aggregated WTRU.

The anchor WTRU may request the aggregated WTRU to report cell selection assistance measurements 1604. The request may include the desired frequency, carriers, PLMN, set of preselected cells (e.g., based on stored knowledge).

The anchor and aggregated WTRUs may perform cell selection measurements, according to their configuration and requested aggregation measurement 1605. The aggregated WTRU may not be required to perform the cell selection assistance measurement if it already performed such measurements in a given configured time window. For each measured frequency, the WTRUs may search for more than the strongest cell, e.g., collect measurement for a configured maximum or minimum number of cells so that multiple choices are available later when combining the anchor and aggregated WTRU measurements. The WTRUs may restrict the cell selection search to only the frequency supported by the aggregated WTRU. The aggregated WTRU may perform measurements on the requested frequencies/carriers obtained from the request and/or configuration.

The WTRUs may apply a configured preprocessing 1606. The preprocessing steps and measurements to be collected for the aggregation (e.g., L1 measurements, RSRP, RSRQ, etc.) may be based on the configuration. For example, an information element Aggregation-measConfig IE may be set to one or more of: L1Sample (A in FIG. 2, 201) FilteredSample (A1 in FIG. 2, 203), RSRP, or RSRQ. RSRP and RSRQ may be L1/L2-based measurement and reports (D in FIG. 2, 209) or L3 measurement and reports (F in FIG. 2, 216).

The aggregated WTRU may report its partially preprocessed measurements to the anchor WTRU, based on the configurated processing steps 1607.

The measurements may be filtered to only include cells that have a signal quality (e.g., RSRP or RSRQ) beyond a configured threshold. The threshold on RSRP or RSRQ may be set in the aggregation RRC configuration, e.g., as a AggregationCellSelection-RSRP-Thresh of type RSRP-Range or AggregationCellSelection-RSRQ-Thresh or RSRP-Range or RSRQ-Range. These thresholds may be aggregation reporting specific (e.g., one threshold for L1 reporting, and one for RSRP reporting) or may be set to a given value based on the configured aggregation reporting type.

The measurements may be filtered to only include cells that are not restricted or barred for the anchor WTRU, e.g., checking that the anchor WTRU type is not barred or that the cell is not restricted for the anchor WTRU, based on the exchanged WTRU information.

The measurements may be filtered to include only cells that are suitable for cell (re)selection of the aggregated WTRU, e.g., satisfying the signal quality criteria for cell selection and that the cell is not barred or reserved for the aggregated WTRU.

The measurements may be filtered to only include cells that support aggregation WTRUs, e.g., with explicit indications in the System Information or that are not restricted/barred for aggregation.

In the case where the aggregated WTRU is camping or served by a cell, it may be configured to report only the signal information from that cell. It may also be configured to report only cells that are suitable for a reselection, so that in case that cell is selected by the anchor, a reselection to that cell by the aggregated is possible.

The anchor WTRU may receive and aggregate the partially preprocessed measurements. The anchor WTRU may resume the measurement processing according to the configured steps, e.g., applying biases based on accuracy of the received measurements or using aggregation specific filters 1608.

The anchor WTRU may determines the RSRP and RSRQ of the aggregation, based on its measurements and the reported measurements 1609. Then the anchor WTRU may select the cell based on the aggregated measurements.

To verify the suitability of a cell as a set of WTRUs, the anchor WTRU verifies the suitability for the aggregation of WTRUs. The criteria are defined in the (pre)configuration or the aggregation (e.g., from the specification or exchanged in Step 1).

To evaluate the signal strength of a cell, the WTRU may determine the RSRP and RSRQ of the aggregated signals and apply a new criteria for the aggregated measurement.

In one embodiment, based on the configuration and received the measurements from the aggregated WTRUs, the anchor WTRU may estimate the RSRP, RSRQ based on the aggregated signals. The aggregated RSRP/RSRQ may be used to evaluate the cell-selection criteria. The RSRP and RSRQ may be used in the cell (re)selection as the value Qrxlevmeas and Qqualmeas, respectively.

The S criterion for cell reselection, to evaluate the RSRP and RSRQ of a cell, may be modified for the case of aggregation. The offsets (e.g., Qqualminoffset Qrxlevminoffset) and minimum requirements (Qrxlevmin and Qqualmin) used in the criteria may be configured separately for the aggregation, e.g., via a SIB, RRC or sidelink, or dedicated RRC signaling.

The cell selection criterion S may be fulfilled when Srxlev>0 and Squal>0, where

Srxlev is the cell selection RX level value (in dB) and is determined as:

Srxlev=Qrxlevmeas−(Qrxlevmin+Qrxlevminoffset)−Pcompensation−Qoffsettemp; where:

Qrxlevmeas: Cell RX level value (Reference Signal Receive Power, RSRP). Measured by the WTRU.

Qrxlevmin: Minimum required RX level in the cell (dBm). Configured by RRC.

Qrxlevminoffset: Offset used while camped in a VPLMN and searching for a higher priority PLMN. Configured by RRC.

Pcompensation: For FR1: dependent on the WTRU power class, configured by RRC. For FR2=0.

Qoffsettemp: Offset temporarily applied to a cell. Configured by RRC.

Qrxlevminoffset: Offset used while camped in a VPLMN and searching for a higher priority PLMN. Configured by RRC.

Qrxlevminoffsetcell: Cell specific offset, added to the corresponding Qrxlevmin to achieve the required minimum RX level in the concerned cell. Configured by RRC.

And Squal is the cell selection quality value (in dB) and is determined as:

Squal=Qqualmeas−(Qqualmin+Qqualminoffset)−Qoffsettemp

Qqualmeas: Cell quality value (Reference Signal Receive Quality, RSRQ). Measured by the WTRU.

Qqualmin: Minimum required quality level in the cell (dB). Configured by RRC.

Qqualminoffset: Offset used while camped in a VPLMN and searching for a for higher priority PLMN. Configured by RRC.

Qoffsettemp: Offset temporarily applied to a cell. Configured by RRC.

The anchor WTRU may receive the RSRP and RSRQ from the aggregated WTRU and determine the Squal value using the parameters that are sent in the anchor's current serving cell. As the measurements are taken by another WTRU, the anchor WTRU may compensate for any discrepancies of the measurements. An additional offset, specific to the aggregation, may be added in the computation of the Srxlev and Squal e.g., QlevOffsetAggregation and QqualOffsetAggregation, respectively. When determining the values of Srxlev and Squal, the anchor WTRU will add or subtract the offset:

Srxlev=Qrxlevmeas−(Qrxlevmin+Qrxlevminoffset)−Pcompensation−Qoffsettemp±QlevOffsetAggregation

Squal=Qqualmeas−(Qqualmin+Qqualminoffset)−Qoffsettemp±QqualOffsetAggregation.

Adding a positive offset yields in a higher probability that the cell reselection criterion S may be fulfilled, e.g., Srxlev>0 and Squal>0. And since the offset changes the Srxlev/Squal value, and the criterion is that these values are greater than zero, subtracting a positive value yields in making the criterion harder to reach.

The offset determination may be pre-provisioned, configured, sent in system information of the current serving cell or sent in a dedicated RRC message. Optionally, it may be received from other WTRUs.

The offset may be distance-based. The offset may be determined based on the distance between the collaborating WTRUs. Several offset values may be configured and be selected based on configured distance thresholds. As one example, a 0 dB offset may apply if the WTRUs are collocated, a 3 dB may apply for WTRUs when the distance between the WTRUs is below a first distance threshold, 5 dB between the first and second distance threshold, and so on. Note that the distance metric can be replaced by evaluating the pathloss between the WTRUs. The collocated/distance aspect can be estimated using the connectivity, e.g., long-range wireless vs. very short-range wireless/wired systems.

The offset may be capability-based. The offset may be determined based on the difference of a selected set of capabilities between the WTRUs. For example, if the assisting WTRU supports beamforming with 4 RX antennas, while the assisted WTRU only supports 2 RX antennas for beamforming, the offset may be configured to 3 dB. The possible combinations of beam capabilities/number of antenna may be configured and then selected by the WTRU based on the exchanged WTRU information. For instance, due to limitations on WTRU capabilities, the measurements that the WTRU performs for cell selection may not reflect the actual cell quality perceived by the WTRU in connected mode. In this case, an offset may be used to benefit WTRUs with a higher capability. For instance, the cell selection measurement processing of the anchor WTRU relies on 2 RX antennas. The aggregated WTRU may report a 2 RX antennas measurement to combine them together, while it may later use 4 RX antennas and get a stronger signal. The offset may be used to compensate for the lack of processing of the anchor compared to the aggregate UE.

The offset may be role-based. The offset may be determined based on the role of the aggregated WTRU in the group, e.g., if the WTRU is a coordinator or a relay/gateway. This offset can be set to favor the grouping WTRUs with that collaborative WTRU.

Specific parameters and offset values may be set for different aggregation types or aggregation size in number of WTRUs. The parameters and offset values may be part of the configuration. For example, the offsets for an aggregation of 2 WTRUs can be different than for the aggregation of 3 or more WTRUs.

In the case of a cell reselection procedure, the offsets may be applied either to Srxlev and Squal during the evaluation of cells from intra or inter-frequency. In another example, may be applied to the thresholds used for inter or intra-frequency evaluations, while keeping the measurement quantities unchanged. An offset value may be further added on a cell that is serving WTRUs in the aggregation group, e.g., serving the aggregated WTRU, to bias the reselection toward a common cell.

For instance:

A cell on a higher-priority frequency may be selected if it fulfils the condition Squal>ThreshX, HighQ+QqualOffsetAggregation_highQ or Srxlev>ThreshX, HighQ+QlevOffsetAggregation_highP when using the aggregated measurements.

A cell on a lower-priority frequency can be selected if it fulfills the condition Squal>ThreshX, LowQ+QqualOffsetAggregation_lowQ or Srxlev>ThreshX, LowQ+QlevOffsetAggregation_lowP when using the aggregated measurements.

For cells in the same frequency as the serving cell or in the frequencies of the same priority, the ranking of cells that are serving the group can be biased using:
Rs=Qmeas,s+Qhyst−Qoffsettemp+QoffsetAggregation if the serving cell is serving the aggregated WTRU (s)
Rn=Qmeas,n−Qoffset−Qoffsettemp+QoffsetAggregation if the other cell is serving the aggregated WTRU (s)

To be a suitable cell, the anchor WTRU may also verify the cell status and restrictions. For example, the cells may forbid certain WTRUs to select them. The indication is sent in the systemlnformation with the cellBarred flags and cellReserved flags. The WTRUs being aggregated, the barring and restriction verification may differ.

In one embodiment, a cell may be considered to be barred for the anchor WTRU if either the anchor WTRU or the aggregated WTRU is barred. This means that at least one WTRU of the aggregation is not authorized to camp or be served by the cell. To determine the restriction at the aggregated side, the anchor WTRU may either receive the barred status from the report (previous step) or based on the WTRU information of the aggregated WTRU (such as WTRU type) and evaluate the barred status using the aggregated WTRU info. For example, if the aggregated WTRU is a RedCap device with 1 Rx antenna and the cell as cellBarredRedCap1Rx=‘barred’ indicated, the aggregated WTRU is barred and so the anchor WTRU may act as if the cell is barred for it too.

In another embodiment, the cell may be considered as barred for the anchor WTRU if the anchor WTRU is barred, even if the aggregated WTRU is barred. In this case, the aggregated WTRU may be assisting the anchor WTRU but may not be considering the reselection to the barred cell, and the anchor may select that cell without impacting the aggregated.

In an alternative embodiment, the cell may be considered as barred for the anchor WTRU if the aggregated WTRU only is barred, even if the anchor WTRU is barred. This way, the aggregated WTRU is capable enough to be served by the cell and assist the anchor WTRU and so the anchor may select that cell.

A new “cellBarred” indication (e.g., “cellBarredAggregation” IE type: “barred” or “not barred”) may be defined and signaled in MIB or SIB1, where the barred indication targets aggregation users. When present and set to “barred”, a WTRU configured in an aggregation group may consider this cell as barred.

The anchor WTRU may inform the aggregated WTRU of the cell selected 1610. After selecting the cell, the anchor WTRU may report the cell selected to the aggregated WTRU. The report may include measurement information such as the aggregated RSRP, RSRQ or SINR obtained with the aggregated WTRU measurement. The report may include any necessary cell information or WTRU information required by the aggregated WTRU to camp on the cell. For instance, the cell ID, its frequency/carrier, cell specific SI, WTRU specific parameters, such as paging occasions, DRX parameters, etc. The anchor WTRU may also report the selected cell to the network, e.g., during location registration procedure (at NAS level). The anchor WTRU may also indicate that the selection has been performed using a collaborative selection, so that the network may keep track of collaboration between users, send collaboration specific parameters (e.g., via SIB) and update the configuration of users based on the collaboration. For example, the network may configure the paging occasions for the WTRUs in the collaboration, send collaboration-specific parameters to both assisted and assisting WTRUs, etc.

Paging may be sent to a collaboration group. Each group may be identified by a collaboration group ID. The collaboration group ID may be cell-specific and unique within a cell. Or it may be location/registration area specific and unique within that area. Or it may be RAN notification area specific. Accordingly, the core network or the base station may trigger a paging to the collaboration group based on the collaboration group ID.

Once camping on the selected cell, the WTRU may monitor control channel to receive SIBs and paging messages.

The anchor WTRU may camp on the selected cell 1611. The aggregated WTRU may camp as an aggregated WTRU and start to monitor signals it is configured to for the aggregation, such as DCI and paging occasions of the anchor WTRU 1612. Note that if the cell is not the one the aggregated WTRU was camping on, the aggregated WTRU may be required to change its camping cell, e.g., by reselection or directly (re)selecting the anchor cell.

When the aggregated WTRU may be associated with an anchor WTRU, the aggregated WTRU may monitor paging occasion and DCIs targeting the anchor's serving cell, in addition to its own cell. The aggregated WTRU may be associated with multiple WTRUs, which may be connected to different cells. In this case, the aggregated WTRU may camp (e.g., monitor DCI, paging occasion) to these cells to assist the corresponding anchor WTRUs.

WTRU A may report the selected cell to the network 1613, e.g., during (NAS) location registration procedure, indicating that the selection has been performed using a PHY aggregation selection (and the associated parameters and collaborative WTRU IDs/info). Optionally, the aggregated WTRU may report the anchor's selected cell to the network.

The network may keep track of collaboration between users, send collaboration specific parameters (e.g., via SIB) and update the configuration of the user based on the collaboration. For example, the network may configure the paging occasions for the WTRUs in the collaboration, send collaboration-specific parameters to both assisted and assisting WTRUs, etc.

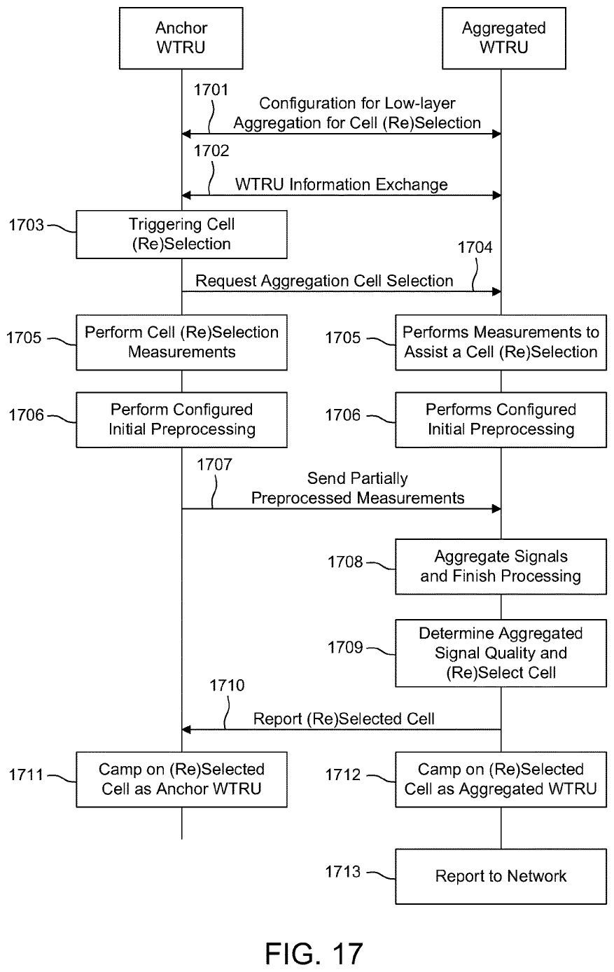

FIG. 17 illustrates a call flow of an example of lower-layer aggregation for cell (re)selection performed by an aggregated WTRU.

Regarding cell (re)selection at the aggregated WTRU side, in an alternative embodiment, the aggregated WTRU may perform the cell selection on behalf of the anchor, based on the measurements reported by the anchor to the aggregated WTRU and its own measurements.

1701 and 1702 in FIG. 17 are similar to 1601 and 1602 in FIG. 16. In this case, the configuration may also include information that the aggregated WTRU may perform the cell (re)selection for the anchor WTRU.

1703 in FIG. 17 is similar to 1603 in FIG. 16. Alternatively, the cell selection for the anchor WTRU may be triggered at the aggregated WTRU side, and an indication may be sent from the aggregated WTRU to the anchor WTRU to trigger the cell selection.

The anchor WTRU may request the cell selection to the aggregated WTRU 1704 (if it was not triggered by the aggregated WTRU itself). The request may include the desired frequency/carriers, PLMN, RAT supported by the anchor WTRU.

1705 and 1706 in FIG. 17 are similar to 1605 and 1606 in FIG. 16. 1707 to 1713 in FIG. 17 are similar to 1607 to 1613 in FIG. 16, but with inversed roles for the anchor WTRU and the aggregated WTRU.

Solutions described so far herein assume the aggregation group was already in place.

Solutions in the case where the aggregation group is not preset and can be determined simultaneously are described. One difference in this case, is that the anchor WTRU may evaluate multiple options of aggregation and the corresponding (estimated) measurement for cell selection.

In this scenario, the anchor WTRU may “know” a set of potential WTRUs to act as the aggregated WTRUs. This may be known from the SL discovery phase and/or from a WTRU group configuration. The aggregation may further be preconfigured and it may be required to activate it in the anchor

The procedure for joint cell and aggregation selection may be similar with the cell selection procedures, but where the procedure may be done in parallel with multiple potential aggregated WTRUs. The determination of the signal may include a comparison of the signals from different combinations of aggregation, and the best combination may lead to the choice of that aggregation and the corresponding cell. The best combination may be, for example, the cell with the strongest RSRP with at least N aggregated WTRUs (where N is a determined/configured number). The anchor WTRU may report to the other WTRUs the cell selected and the selection of the aggregation.

In an alternative approach, the anchor WTRU may iteratively perform cell selection procedures with different aggregation groups (or without aggregation), and select the aggregation that best satisfies the cell selection criteria.

For instance, the anchor WTRU may first perform a cell selection without aggregation. If no cell is suitable or if the WTRU cannot camp normally on a cell, it may attempt a cell selection with an aggregated WTRU, and repeat until the cell selection is successful.

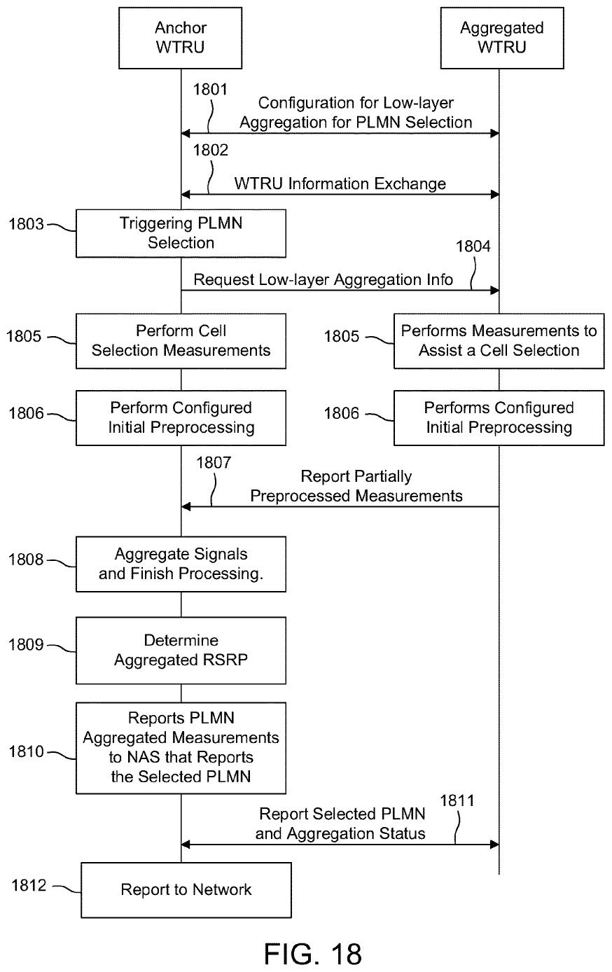

FIG. 18 illustrates a call flow of an example of lower-layer aggregation for PLMN selection performed by an aggregated WTRU.

In FIG. 18, an aggregated WTRU assists an anchor WTRU to perform measurements of the PLMN selection. The initial configuration 1801 may include the parameters for the PLMN selection. For instance, the parameter value for the high-quality PLMN criterion. The criterion may be changed for the specific purpose of the PLMN selection with aggregated WTRUs, or an offset may be applied to the typical −110 dBm criterion.

1802 in FIG. 18 is similar to 1602 in FIG. 16.

The anchor WTRU may be triggered to perform a PLMN selection 1803. For example, the anchor WTRU may request collaborative PLMN selection when its battery level is low; or when the WTRU is at the cell edge or failed to find a PLMN of high-quality in a previous attempt; or when there is a change in the WTRU collaboration group (e.g., a new assisting WTRU). Triggers for the PLMN selection may include when the anchor WTRU turns on the Uu radio, or when the selected PLMN is not the highest-priority PLMN and a new selection attempt is performed regularly. The collaboration may be requested to be activated regularly (e.g., periodic measurements) or as a one-shot collaboration. The periodic collaboration may be stopped when the WTRU successfully selected its highest-priority PLMN.

1804 in FIG. 18 is similar to 1604 in FIG. 16, but the request may indicate the PLMN selection parameters, such as supported frequencies and carriers, supported or preferred PLMNs. The measurements requested for PLMN selection (from the request or the configuration) are the cell's RSRP.

1805 and 1806 in FIG. 18 are similar to 1605 and 1606 in FIG. 16. The WTRUs may perform measurements to assist the PLMN selection on the configured or requested frequencies and carriers. The aggregated and anchor WTRUs may restrict the other WTRUs' measurements on the frequency, carriers, for the PLMN supported by the anchors and/or the aggregated WTRUs. WTRUs may only support some of the carriers and/or PLMNs available, and the support/capabilities are different from one WTRU to another. WTRUs may indicated to each other which carriers/PLMNs are supported to avoid unnecessary measurements and reporting during the collaboration process.

1807 in FIG. 18 is similar to 1607 in FIG. 16, but where the reports are for the PLMN measurements, based on the (pre)configuration. The report may include, for each frequency, the PLMN, corresponding cell ID, frequency information, location of the measurement, CQI, CSI. The report may be filtered to remove the measurements of PLMNs not satisfying the aggregation high-quality criteria.

1808 and 1809 in FIG. 18 are similar to 1608 and 1609 in FIG. 16. for aggregation, processing, and determination of the RSRP Specific parameters and offset values may be (pre)configured for the PLMN selection.

the anchor WTRU AS layer may evaluate the PLMN RSRPs, and report the high quality RSRPs to the NAS 1810. The criterion for high-quality RSRP may be based on the (pre)configuration. The WTRU may further report the aggregation configuration used to obtain this RSRP to the NAS, so that the NAS may use the aggregation information as an input for the PLMN selection. The NAS may perform the PLMN selection, and report to the WTRU's AS layer.

The NAS in the anchor WTRU may report the selected PLMN and, if necessary, report the selected aggregation to the aggregated WTRUs 1811.

The anchor WTRU may report the aggregation-based PLMN selection to the network 1812, e.g., during the NAS registration. It may indicate the configuration of the aggregation, and the members of the group to the network.

In an alternative embodiment, for a jointly selection of the aggregation scheme and the PLMN, the anchor WTRU may perform 1801 to 1809 in parallel, with different potential aggregated WTRUs.

In one example, the anchor WTRU AS layer may report multiple PLMN values and WTRU aggregation schemes to the NAS 1810. The NAS may select the best combination of PLMN and aggregation at once. In another example, the WTRU anchor AS layer may report to the NAS the best aggregation scheme for each frequency, and the NAS may select the PLMN, without consideration of the aggregation. Alternatively, The WTRU anchor AS layer may report the best aggregation to the NAS for each frequency, and the NAS may select the PLMN without consideration of the aggregation. After reporting the PLMN to the AS layer, the anchor WTRU's AS layer selects the aggregation that corresponds to the selected and reported PLMN.

In an alternative embodiment, the PLMN selection is performed iteratively, where the WTRU may first obtain a high-quality PLMN without aggregation, and if not, retry with different aggregation options, until a PLMN RSRP is estimated with high quality.

In an alternative embodiment, the PLMN selection of the anchor WTRU may be performed at the aggregated WTRU side instead of at the anchor side, as described in previous paragraphs.

For the case where WTRUs may exchange measurement results, measurements may be aggregated, and the output reflects actual joint-processing signal quality or strength. However, the exchange of measurement may require an active sidelink transmission and may introduce delays to wait for the other WTRU feedback. In another example, cell/PLMN (re)selection for aggregated WTRUs may be performed without sharing measurements. The WTRU evaluates the criterion for cell selection based on its own measurement and an estimate of the aggregated signal. Compared to other embodiments, this embodiment can reduce the accuracy of the aggregated measurement but can improve access delay and can reduce the need for active communications.

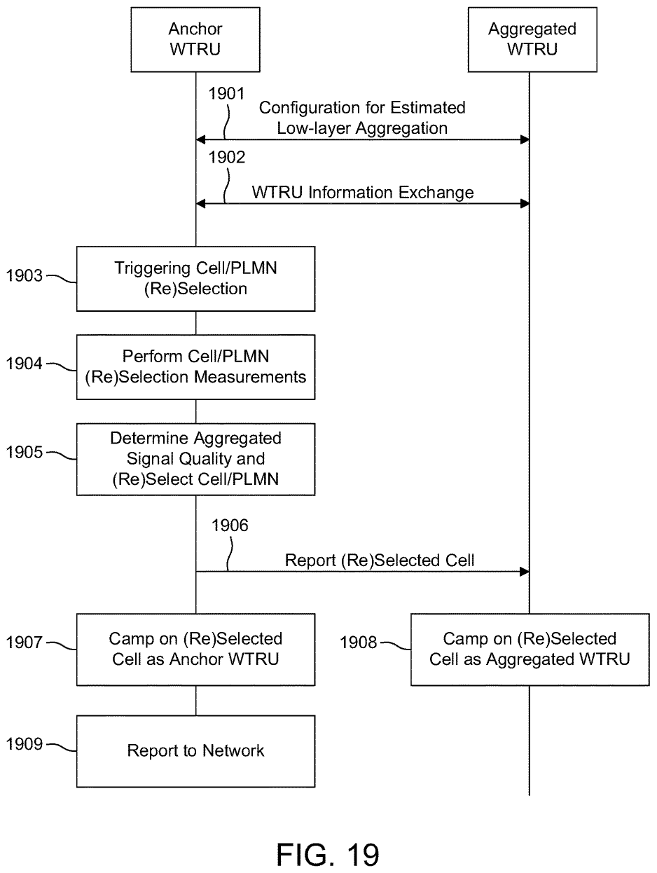

FIG. 19 illustrates a flow diagram of an example of cell/PLMN (re)selection procedure with estimated aggregation measurements.

An anchor WTRU and an aggregated WTRU may exchange the configuration for the low-layer aggregation for the cell selection 1901. The WTRUs may be configured to perform an estimation of the aggregated measurement instead of exchanging on-demand measurements. Some WTRU information may need to be exchanged regularly (e.g., periodically or based on change triggers), such as WTRU position, WTRU selected cell if any, WTRU measurements, SL measurements, to assist the anchor WTRU perform the estimation.

Some information may be regularly exchanged to keep the WTRU s updated 1902. This may be based on a (pre)configuration.

The WTRU may check for the configured mode of operation (whether it may estimate the aggregated WTRU measurements or it may receive a measurement report from the aggregated WTRU) to perform the aggregation-based cell selection. The following assumes that the WTRU is configured to perform the selection based on estimated measurement instead of on-demand ones.

Cell selection may be triggered 1903. The Anchor WTRU may perform the cell selection measurements as required by its cell selection procedure 1904.

The anchor WTRU may evaluate and perform cell selection based on its measurements and the aggregated WTRU information 1905.

In an embodiment, the anchor WTRU may apply an offset when evaluating the S criterion (and sub-criteria Srxlev>0 and Squal>0) to account for an estimated gain in signal strength due to the (potential) aggregation. In two different implementations, the offset may be either applied to the defining criteria (e.g., Srxlev and Squal) or to the measurement itself (e.g., Qrxlevmeas and Qqualmeas).

As an example, an offset, Qoffset_aggregation, may be defined (e.g., set as RRC parameter or in the SL aggregation configuration to +3 dB for the case with 2 WTRU s in aggregation) and used to modify the computation of Srxlev as:

Srxlev=Qrxlevmeas−(Qrxlevmin+Qrxlevminoffset)−Pcompensation−Qoffsettemp+Qoffsetaggregation

Specific parameters and offset values may be set for different aggregation types or size, and part of the (pre)configuration. For example, the offsets for an aggregation of 2 WTRUs may be different from the ones for the aggregation of 3 or more WTRUs. The signal quality expected from aggregation with more WTRU should be better than a aggregation with a single aggregated WTRU, so the offset may reflect the expected gain. For example: 1 aggregated WTRU->+3 dB, 2 aggregated WTRU: +6 dB, etc. As another example, the parameters and offset may be different depending on the connection between the WTRU s, e.g., whether the WTRUs use 3GPP NR SL, or other wireless or non-wireless technologies. The aggregated signal processing may depend on the quality of the inter-UE link (ideal, high-bitrate, low-bitrate etc.) and that may potentially impact the gain of the combined signal. Similar principle applies for both RSRP and RSRQ evaluations. For example, the signal quality expected from aggregation with more WTRU may be more accurate than a aggregation with a single aggregated WTRU, so the offset may reflect the expected gain. For example, for 1 aggregated WTRU, the offset may be 3 dB, for 2 aggregated WTRUs it may be 6 dB, etc.

In the case where the anchor WTRU has some knowledge about the WTRU aggregation conditions, it may be preferable to apply an offset on the measurement itself, i.e., modifying the Qrxlevmeas or including the offset in the measurement processing in previous Step. The offset applied to measurements may also be cell and aggregating WTRU specific.

For example, the anchor WTRU may have received indications about the aggregated WTRU location and estimated that the two WTRU s are close to each other (e.g., based on WTRU positions/distance or based on SL signal strength or inter-WTRU inter-connection mode); the WTRU may anticipate a similar signal strength at both WTRU s′ side and thus apply a +3 dB gain to its own signal.

As another example, the anchor WTRU may have received indications about the serving cell (or a selected set of cells) of the aggregated WTRU and may apply offset gains to these cell's measurements only. For instance, if the aggregated WTRU is in a given serving cell, it may be beneficial for the anchor WTRU to selects the same serving cell. In this case, an offset in favor of the selection of the same cell may be utilized.

The offset may also can include the power class and radio/processing capabilities of the aggregated WTRU or the difference in power and capabilities. For instance, if the aggregated WTRU has a maximum power 6 dB higher than that of the anchor WTRU, the anchor WTRU may apply a 6 dB gain to its signal.

For example, the aggregated WTRU may relay or combine its signals with the anchor WTRU signal. If the aggregated WTRU has a stronger transmit power, it's UL signal may be better either for relaying or combining the signals to the selected cell, so the WTRU may expect a significant signal boost, thus an offset to ease the passing of criterion to that cell may be beneficial.

The anchor WTRU may perform its cell selection based on the (modified) measured cells and (modified) criteria.

The anchor may notify the aggregated WTRU of the selected cell 1906 and camp on the cell as an anchor WTRU 1907. The aggregated may camp on the selected cell as an aggregated WTRU 1908.

The anchor WTRU may report the selection to the network, indicating the aggregation configuration and aggregated WTRU IDs 1909.

In the case where the estimation of the aggregated measurement for PLMN selection, a similar procedure can apply, where the offset on the criteria in Step 5 is now applied to the threshold for the high-quality criteria, i.e., to lower the requirement so that a PLMN could be considered with lower RSRP.

In the case where the cell or PLMN selection is performed at the aggregated WTRU side, the procedure can be changed in the same spirit as in conjunction with FIG. 16, i.e., where the Steps 4 and 5 are performed at the aggregated WTRU side and using the aggregated WTRU's measurement as baseline or reference.

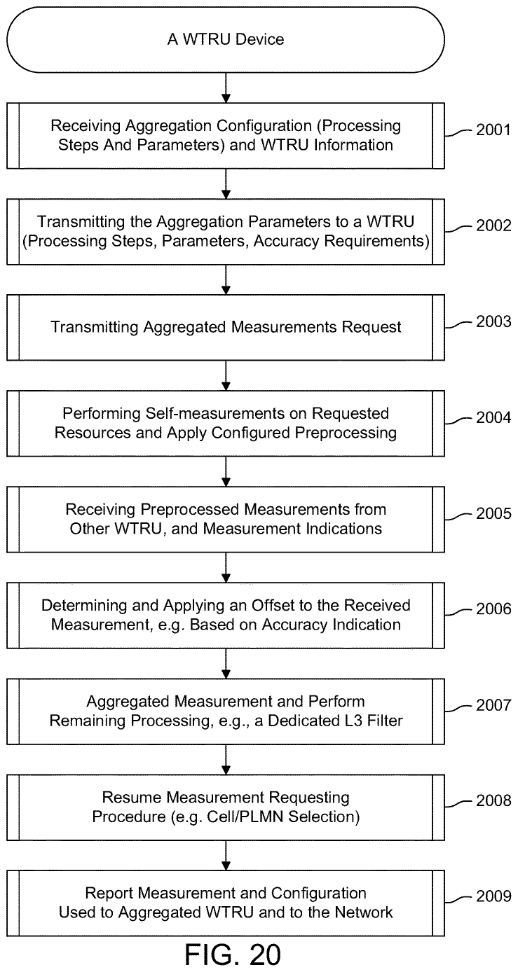

FIG. 20 illustrates a flow diagram of an example of a method for low-layer PHY aggregation measurements for an anchor WTRU.

In an embodiment related to low-layer PHY aggregation of measurements, an anchor WTRU may configured to request, collect, and aggregate measurement from another WTRU. An anchor WTRU may receive WTRU information and configuration from an aggregated WTRU 2001. WTRU Information and status may include, e.g., WTRU capabilities, position, battery level information, capabilities of the inter-connection such as the PC5 radio-interface, radio conditions, PC5 resource availability, measurement accuracy, etc. Configuration may include aggregation triggers (e.g., based on coverage, battery levels), processing steps for aggregation (e.g., aggregate after L1 filtering), aggregation specific parameters (e.g., L1 and L3 filter weights, accuracy configuration).

The WTRU may transmit configuration for aggregation measurement to an aggregated WTRU for cell/PLMN selection, e.g., using SL transmission 2002. The configuration may include processing steps for aggregation (e.g., transmit after L1 filtering), aggregation specific parameters (e.g., L1 and L3 filter weights, accuracy configuration).

The WTRU may transmit the aggregated measurement request to the aggregated WTRU 2003. This may be triggered by measurement requested for a cell selection, cell reselection, PLMN selection procedure. The measurements may include the measurement configuration (e.g., RS to measure, processing steps).

The WTRU may perform measurements of the spectrum and performs the preprocessing steps based on configuration (e.g., L1 filter based on configuration and accuracy requirement) 2004.

The WTRU may receive the preprocessed measurement from the aggregated WTRU and an indication of the accuracy requirements used 2005.

The WTRU may determine and apply the offset to the received measurement based on the configuration and received accuracy indication 2006.

The WTRU may aggregate the received measurements and resume the processing of the measurements 2007. Processing steps may be configured specifically for aggregated measurements, e.g., a dedicated configured L3 filter.

The WTRU may report the aggregated measurement to the requesting layer/procedure entity and resume the corresponding procedure, e.g., cell selection, cell reselection or PLMN selection 2008.

The WTRU may report the aggregated measurement results (e.g., aggregated RSRP, selected cell/PLMN) and configuration to the aggregated WTRU 2009. The WTRU may report the aggregation configuration (e.g., aggregated WTRU ID, measurement, selected cell/PLMN, and offset parameters) to the network.

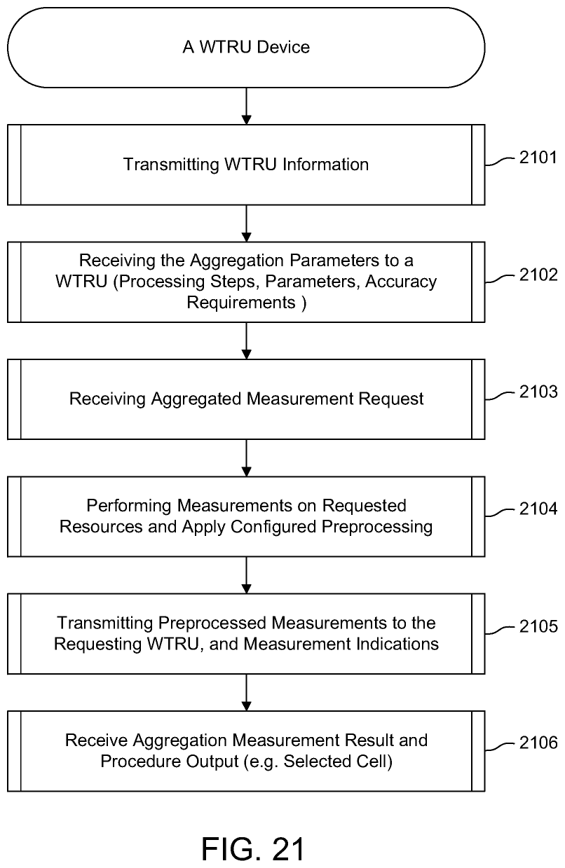

FIG. 21 illustrates a flow diagram of an example of a method for low-layer PHY aggregation measurements for an aggregated WTRU.

An aggregated WTRU may assist an anchor WTRU to perform cell or PLMN selection. It may receive a measurement request including measurement processing configuration and requirement and reports the measurements with specific configured preprocessing.

An aggregated WTRU may transmit WTRU information to an anchor WTRU or to the network 2101. The WTRU information and status may include, e.g., WTRU capabilities, position, battery level information, capabilities of the inter-connection such as the PC5 radio-interface, radio conditions, PC5 resource availability, etc.

The WTRU may receive configuration for aggregation measurement from an aggregated WTRU using SL transmission, e.g., for cell/PLMN selection 2102. Configuration may include processing steps for aggregation (e.g., transmit after L1 filtering), aggregation specific parameters (e.g., L1 and L3 filter weights, accuracy configuration).

The WTRU may receive the aggregated measurement request from the anchor WTRU, including the spectrum to be scanned 2103.

The WTRU may perform measurements as per received configuration and apply configured preprocessing/filtering 2104. Preprocessing (e.g., L1 filter weights) may be based on request and WTRU capabilities.

The WTRU may sub-select measurements based on configured criteria of their signal quality/strength.

The WTRU may transmit the preprocessed measurements to the anchor WTRU 2105. The measurements may include the accuracy of the measurement used. In an embodiment, the WTRU only sends an indication if the requested accuracy requirement is not met.

The WTRU may receive the aggregated measurement results and a cell/PLMN (re)selection indication from the anchor WTRU, and optionally change the PLMN selected, or the cell camped on 2106.

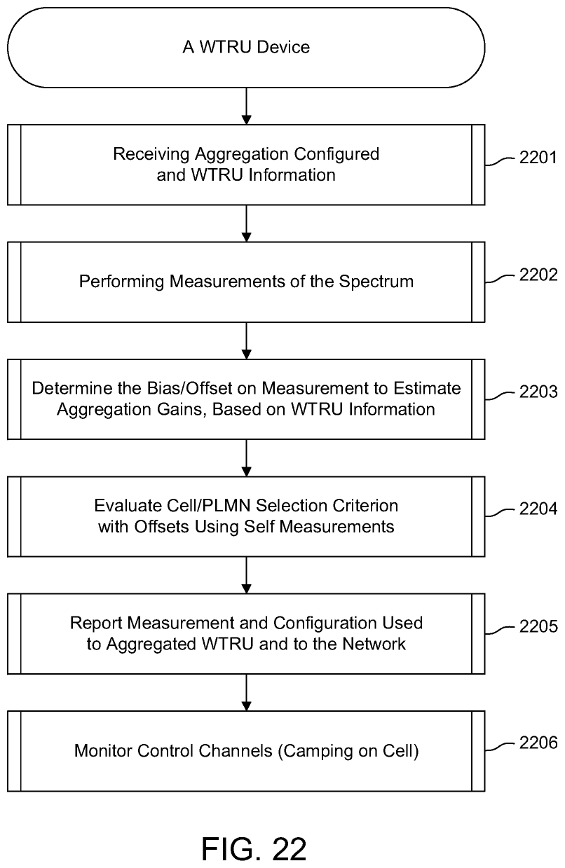

FIG. 22 illustrates a flow diagram of an example of a method for cell selection for an anchor WTRU with low-layer PHY measurement aggregation estimation.

An anchor WTRU may perform cell (re)selection or PLMN selection using estimated aggregated measurements. Without requesting an on-demand measurement, the aggregated measurements may be estimated and used to evaluate the suitability for cell/PLMN selection with specific criteria.

The anchor WTRU may receive WTRU information from an estimated aggregated WTRU and configurations 2201. The WTRU Information and status may include, e.g., WTRU capabilities, position, battery level information, capabilities of the inter-connection such as the PC5 radio-interface, radio conditions, PC5 resource availability, etc. The configuration may include estimated aggregation triggers (e.g., based on coverage, battery levels), estimated aggregation specific thresholds and parameters (e.g., offsets for RSRP/RSRQ).

The WTRU may perform measurements of the spectrum for a cell (re)selection or PLMN selection procedure 2202.

The WTRU may determine the offsets for the evaluation of the measurement based on the aggregation configuration for cell/PLMN (re)selection thresholds and WTRU information 2203. In one example, a 3 dB offset may be used when the aggregated WTRU is not collocated with the anchor WTRU. In another example, a 3 dB offset when the aggregated WTRU has twice the number of antennas as the anchor WTRU.

The WTRU may evaluate the measurements and check for the cell/PLMN (re)selection criteria 2204. The evaluation may be based on applying the bias as an offset on the Srxlev/high-quality criteria. Alternately, the offset may be applied on the measurement instead of the threshold. The WTRU may verify the suitability of the selected cell and camp on it.

The WTRU may transmit, to the aggregated WTRU, the selected cell (e.g., cell ID, PLMN, frequency, RAT) or PLMN (e.g., PLMN ID, frequency, RAT) 2205. The WTRU may transmit, to the network, an indication of (re)selected cell/PLMN and the aggregation information, e.g., through registration procedures.

The WTRU may camp on the selected cell and monitor control channels 2206, e.g., to receive paging/SIB messages, of the selected cell.

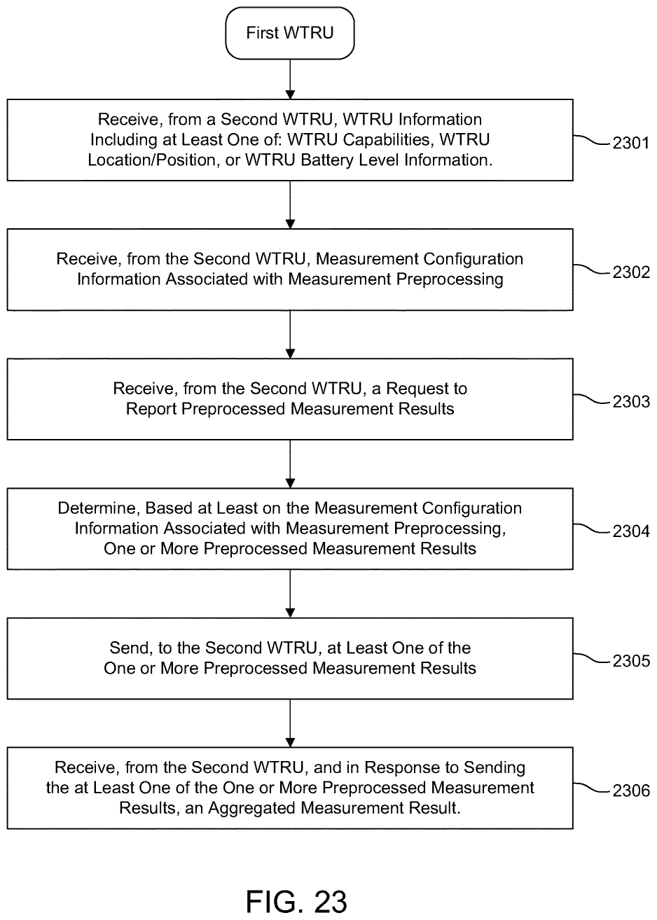

FIG. 23 illustrates a flow chart of an example of a measurement aggregation procedure. A first WTRU may receive, from a second WTRU, WTRU information including at least one of: WTRU capabilities, WTRU location/position, or WTRU battery level information 2301. The first WTRU may receive, from the second WTRU, measurement configuration information associated with measurement preprocessing 2302. The measurement configuration information associated with measurement preprocessing may include L1 filter coefficients. The measurement configuration information associated with measurement preprocessing may include information on reference signals to measure and preprocess. The measurement configuration information associated with measurement preprocessing may include a reporting timing information, wherein the reporting timing information includes at least one of: report once, report periodically, or report based on an event.

The first WTRU may receive, from the second WTRU, a request to report preprocessed measurement results 2303. The preprocessed measurements requested may include a reference signal receive power (RSRP) or a reference signal receive quality (RSRQ).

The first WTRU may determine, based at least on the measurement configuration information associated with measurement preprocessing, one or more preprocessed measurement results 2304. The one or more pre-processed measurement results may include at least one of: raw measurement samples (“A”, FIG. 2, 201), Layer 1 filtered measurements (“A1”, FIG. 2, 203), Layer 3 filtered beam measurements (“E”, FIG. 2, 212), cell quality (“B”, FIG. 2, 205), filtered cell quality (“C”, FIG. 2, 207) or RSRP (“D”, FIG. 2, 209). The Layer 3 filtered beam measurements may include one of a beam consolidation, a beam selection, or a Layer 3 beam filtering.

The first WTRU may send, to the second WTRU, at least one of the one or more preprocessed measurement results 2305. The first WTRU may receive, from the second WTRU, and in response to sending the at least one of the one or more preprocessed measurement results, an aggregated measurement result 2306.

The first WTRU may be a relay WTRU, aggregated WTRU, or assisting WTRU.

The second WTRU may be a remote WTRU, anchor WTRU, or assisted WTRU.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method performed by a first wireless transmit/receive unit (WTRU), the method comprising:
receiving, from a second WTRU, measurement configuration information associated with measurement preprocessing;
determining, at the first WTRU, based at least on the measurement configuration information, one or more preprocessed measurement results;
sending, to the second WTRU, the one or more preprocessed measurement results; and
receiving, from the second WTRU, in response to sending the one or more preprocessed measurement results, aggregated measurement results.

2. The method of claim 1, wherein the measurement configuration information associated with measurement preprocessing includes information on reference signals to measure.

3. The method of claim 1, wherein the measurement configuration information associated with measurement preprocessing includes reporting timing information, wherein the reporting timing information indicates at least one of: reporting once, reporting periodically, or reporting based on an event.

4. The method of claim 1, wherein the measurement configuration information associated with measurement preprocessing includes one or more of: Layer 1 filter coefficients or Layer 3 filter coefficients.

5. The method of claim 1, wherein the one or more preprocessed measurement results include Layer 1 filtered measurement results.

6. The method of claim 1, wherein the aggregated measurement results include results of applying a Layer 3 filter to at least the one or more preprocessed measurement results from the first WTRU.

7. The method of claim 6, wherein Layer 3 filter coefficients include one or more Layer 3 aggregated filter coefficients, wherein the Layer 3 aggregated filter coefficients are configured by a network and to be used for measurement aggregation.

8. The method of claim 1, further comprising, receiving, from the second WTRU, second WTRU information indicating at least one of: WTRU capabilities, a WTRU location/position, or WTRU battery level information.

9. The method of claim 1, wherein the first WTRU operates as a relay WTRU and the second WTRU operates as a remote WTRU.

10. The method of claim 1, wherein the preprocessed measurement results include at least one of Layer 1 filtered reference signal receive power (RSRP) or Layer 1 filtered reference signal receive quality (RSRQ).

11. A first wireless transmit-receive unit (WTRU), the first WTRU comprising at least one processor and a transceiver, wherein the at least one processor and transceiver are configured to:
receive, from a second WTRU, measurement configuration information associated with measurement preprocessing;
determine, at the first WTRU, based at least on the measurement configuration information, one or more preprocessed measurement results;
send, to the second WTRU, the one or more preprocessed measurement results; and
receive, from the second WTRU, in response to sending the one or more preprocessed measurement results, aggregated measurement results.

12. The WTRU of claim 11, wherein the measurement configuration information associated with measurement preprocessing includes information on reference signals to measure.

13. The WTRU of claim 11, wherein the measurement configuration information associated with measurement preprocessing includes reporting timing information, wherein the reporting timing information indicates at least one of: reporting once, reporting periodically, or reporting based on an event.

14. The WTRU of claim 11, wherein the measurement configuration information associated with measurement preprocessing includes one or more of: Layer 1 filter coefficients or Layer 3 filter coefficients.

15. The WTRU of claim 11, wherein the one or more preprocessed measurement results include Layer 1 filtered measurement results.

16. The WTRU of claim 11, wherein the aggregated measurement results include results of applying a Layer filter to at least the one or more preprocessed measurement results from the first WTRU.

17. The WTRU of claim 16, wherein Layer 3 filter coefficients include one or more Layer 3 aggregated filter coefficients, wherein the Layer 3 aggregated filter coefficients are configured by a network and to be used for measurement aggregation.

18. The WTRU of claim 11, wherein the at least one processor and transceiver are further configured to receive, from the second WTRU, second WTRU information indicating at least one of: WTRU capabilities, WTRU location/position, or WTRU battery level information.

19. The WTRU of claim 11, wherein the first WTRU is configured to operate as a relay WTRU and the second WTRU is configured to operate as a remote WTRU.

20. The WTRU of claim 11, wherein the preprocessed measurement results include at least one of Layer 1 filtered reference signal receive power (RSRP) or Layer 1 filtered reference signal receive quality (RSRQ).
